(19) United States
(12) Patent Application Publication
(10) Pub. No.: US 2015/0095042 A1
(43) Pub. Date: Apr. 2, 2015

(54) HIGH/LOW BLOOD GLUCOSE RISK ASSESSMENT SYSTEMS AND METHODS

(71) Applicant: Roche Diagnostics Operations, Inc., Indianapolis, IN (US)

(72) Inventors: Timothy N. Aykroyd, Carmel, IN (US); Amy C. Day, Fishers, IN (US); Paul J. Galley, Cumberland, IN (US); Sebastiaan la Bastide, Carmel, IN (US); Christen A. Rees, Indianapolis, IN (US); Nigel A. Surridge, Indianapolis, IN (US)

(73) Assignee: Roche Diagnostics Operations, Inc., Indianapolis, IN (US)

(21) Appl. No.: 14/039,762

(22) Filed: Sep. 27, 2013

(51) Int. Cl. G06F 19/00

(52) U.S. Cl. CPC G06F 19/3431; G06F 19/3418
USPC 705/2

(57) ABSTRACT

A blood glucose (bG) measurement engine selectively measures bG levels in blood samples input to a handheld diabetes management device. A computer readable medium includes code executed by a processor to: identify a period of N days, the period including the current date and N−1 days immediately prior to the current date, wherein N is an integer greater than 6; determine a total number of the N days during which the patient input at least two blood samples; and, when the total number of the N days is greater than M, M being an integer greater than zero and less than or equal to N: calculate a value based on the bG levels of blood samples input during the period; based on the value, classify the patient as having a first, second, or third risk of being hypoglycemic in the future.

### FIELD

The present disclosure relates to handheld medical devices and more particularly to systems and methods for analyzing a user's risk of hypoglycemia and hyperglycemia.

### BACKGROUND

Persons with diabetes have difficulty regulating blood glucose levels in their bodies. As a consequence, many of these persons carry specialized electronic meters, called blood glucose meters, which allow them to periodically measure their glucose levels and take appropriate action, such as administering insulin. These persons may also carry with them a portable communication device, such as a mobile phone, a personal digital assistant, a tablet or similar device. People often rely on their portable communication device as the primary means for planning, scheduling and communicating with others. As a result, most portable communication devices are equipped with sophisticated software which provides user-friendly means for viewings and inputting data.

User interfaces of handheld diabetes management devices, including blood glucose meters, may be limited to limit the complication associated with operating the diabetes management device. There is a need for handheld diabetes management devices that, while having limited user interfaces, have easily user-configurable reminders for taking blood glucose (bG) measurements, automatically classify blood samples as a specific type of bG measurement, and identify and notify a user of trends in stored bG measurement data. There is also a need for handheld diabetes management devices that determine and indicate a user's risk of hypoglycemia and/or hyperglycemia.

The background description provided herein is for the purpose of generally presenting the context of the disclosure. Work of the presently named inventors, to the extent it is described in this background section, as well as aspects of the description that cannot otherwise qualify as prior art at the time of filing, are neither expressly nor impliedly admitted as prior art against the present disclosure.

### SUMMARY

A handheld diabetes management device for assessing a patient's risk of future hypoglycemia is disclosed. A blood glucose (bG) measurement engine selectively measures bG levels in blood samples input to the handheld diabetes management device. A computer readable medium includes code executed by a processor to: identify a period of N days, the period including the current date and N−1 days immediately prior to the current date, wherein N is an integer greater than 6; determine a total number of the N days during which the patient input at least two blood samples to the handheld diabetes management device; and, when the total number of the N days is greater than M, M being an integer greater than zero and less than or equal to N: calculate a value based on the bG levels of blood samples input to the handheld diabetes management device during the period; based on the value, classify the patient as having a first, second, or third risk of being hypoglycemic in the future, the second risk being greater than the first risk, and the third risk being greater than the second risk; and display the classification of the patient's risk of being hypoglycemic on the display.

A method for assessing a patient's risk of future hypoglycemia using a handheld diabetes management devices is also disclosed. The method includes: determining blood glucose (bG) values based on blood samples input to the handheld diabetes management device, each of the bG values indicative of an amount of glucose in one of the blood samples; tracking a current date and time; identifying a period of N days, the period including the current date and N−1 days immediately prior to the current date, wherein N is an integer greater than 6; determining a total number of the N days during which the patient input at least two blood samples to the handheld diabetes management device; and, when the total number of the N days is greater than M, M being an integer greater than zero and less than or equal to N: calculating a low blood glucose index (LBGI) value based on the bG values of blood samples input to the handheld diabetes management device during the period; based on the LBGI value, classifying the patient as having a first, second, or third risk of being hypoglycemic in the future, the second risk being greater than the first risk, and the third risk being greater than the second risk; and displaying the classification of the patient's risk of being hypoglycemic on a display of the handheld diabetes management device

A diabetes management system for assessing a patient's risk of future hypoglycemia is also disclosed. A handheld diabetes management device includes: a blood glucose (bG) measurement engine that selectively measures bG levels in blood samples input to the handheld diabetes management device; and a communication module that selectively transmits data indicative of stored bG data. A mobile device is external to the handheld diabetes management device, receives the data indicative of the stored bG data from the handheld diabetes management device. The mobile device: identifies a period of N days, the period including a current date and N−1 days immediately prior to the current date, wherein N is an integer greater than 6; determines a total number of the N days during which the patient input at least two blood samples to the handheld diabetes management device; and, when the total number of the N days is greater than M, M being an integer greater than zero and less than or equal to N: calculates a value based on the bG levels of blood samples input to the handheld diabetes management device during the period; based on the value, classifies the patient as having a first, second, or third risk of being hypoglycemic in the future, the second risk being greater than the first risk, and the third risk being greater than the second risk; and displays the classification of the patient's risk of being hypoglycemic on a display of the mobile device.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a patient and a health care professional along with various devices that can be used to help the patient monitor and control health;

FIG. 2 shows a patient with a continuous glucose monitor (CGM), an ambulatory durable insulin infusion pump, an ambulatory non-durable insulin infusion pump, and a blood glucose (bG) management device;

FIG. 3 shows a diabetes care system of systems that can be used to manage diabetes;

FIG. 4 is a high level diagram of an example implementation of a diabetes management device;

FIG. 5 includes a functional block diagram of an example implementation of a diabetes management device;

FIGS. 6-7 include example illustrations of various data stored in a computer readable medium;

FIG. 8 includes a flowchart depicting an example method of generating a reminder to measure bG for an event;

FIG. 9 includes a flowchart depicting an example method of generating a reminder to measure bG after a meal;

FIG. 10 includes an example method of generating a reminder to measure bG after a hypoglycemic blood sample is provided;

FIG. 11A includes a flowchart depicting an example method of notifying a user that a diabetes management device is capable of providing reminders for events;

FIG. 11B includes a flowchart depicting an example method of notifying a user that a diabetes management device is capable of performing pattern recognition;

FIG. 12 includes a flowchart depicting an example method of identifying and displaying patterns in bG sample data;

FIG. 13 includes a flowchart depicting an example method of, based on recognition of a pattern associated with a daily event, displaying a reminder of the presence of the pattern at an event before that event;

FIG. 14 includes a flowchart depicting an example method of displaying previously recognized patterns in bG sample data;

FIGS. 15 and 16 include flowcharts depicting example methods of calculating and displaying the user's risk of having hypoglycemia during a predetermined period in the future;

FIGS. 17 and 18 include flowcharts depicting example methods of calculating and displaying the user's risk of having hyperglycemia during a predetermined period in the future;

FIG. 19 includes a flowchart depicting an example method of notifying a user that sufficient data has been input for performance of hyperglycemic and/or hypoglycemic risk assessments; and

FIG. 20 is a functional block diagram of an example diabetes management system.

### DETAILED DESCRIPTION

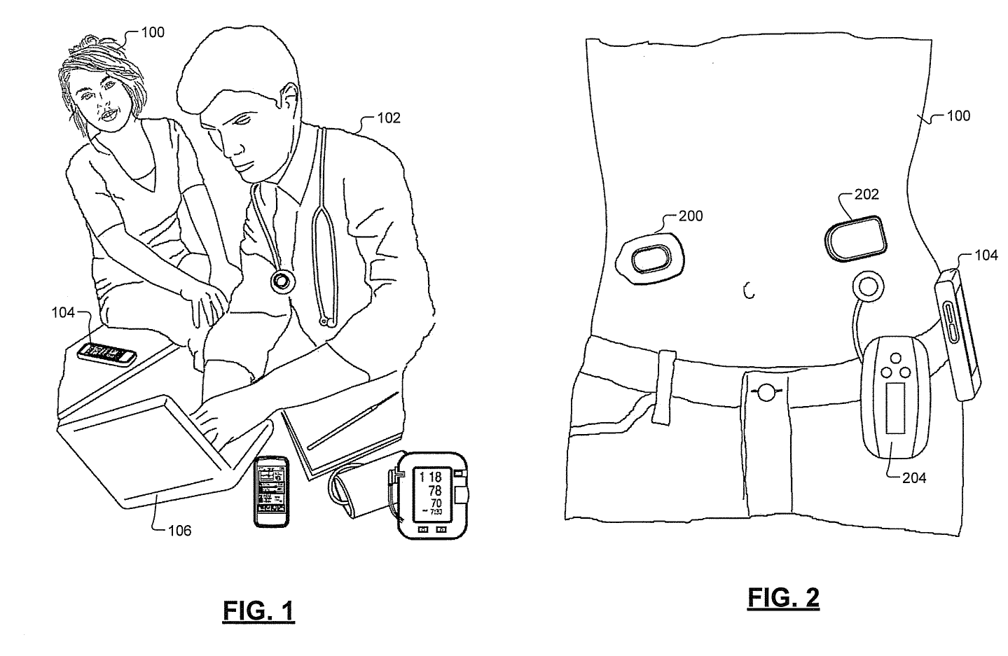

Referring now to FIG. 1, a patient 100 with diabetes and a health care professional 102 are shown in a clinical environment. The patient 100 with diabetes can be diagnosed with a metabolic syndrome, pre-diabetes, type 1 diabetes, type 2 diabetes, gestational diabetes, etc. Healthcare providers for diabetes are diverse and include nurses, nurse practitioners, physicians, endocrinologists, and others and are collectively referred to as health care professionals.

During a health care consultation, the patient 100 typically shares with the health care professional 102 a variety of data including blood glucose (bG) measurements, continuous glucose monitor data, amounts and type of insulin administered, amounts of food and beverages consumed, exercise schedules, health status, and other lifestyle information. The health care professional 102 can obtain additional data for the patient 100, such as measurements of HbA1C, cholesterol levels, plasma glucose, triglycerides, blood pressure, and weight. The data can be recorded manually or electronically on a handheld diabetes management device 104 (e.g., a handheld bG monitor device), diabetes analysis software executed on a personal computer (PC) 106, and/or a web-based diabetes analysis site. The health care professional 102 can analyze the patient data manually or electronically using the diabetes analysis software and/or the web-based diabetes analysis site. After analyzing the data and reviewing how efficacious previously prescribed therapy is and how well the patient 100 followed the previously prescribed therapy, the health care professional 102 can decide whether to modify a therapy prescribed for the patient 100.

Referring now to FIG. 2, the patient 100 can use a continuous glucose monitor (CGM) 200, an ambulatory durable insulin infusion pump 204 or an ambulatory non-durable insulin infusion pump 202 (collectively insulin pump 204), and the diabetes management device 104. The CGM 200 can use a subcutaneous sensor to sense and monitor the amount of glucose (e.g., glucose concentration) of the patient 100. The CGM 200 communicates glucose measurements to the diabetes management device 104.

The diabetes management device 104 performs various tasks including measuring and recording bG measurements, determining an amount of insulin to be administered to the patient 100 via the insulin pump 204, receiving user input via a user interface, archiving data, performing structured bG tests, etc. The diabetes management device 104 can transmit instructions to the insulin pump 204, and the insulin pump 204 selectively delivers insulin to the patient 100. Insulin can be delivered in the form of a meal bolus dose, a correction bolus dose, a basal dose, etc.

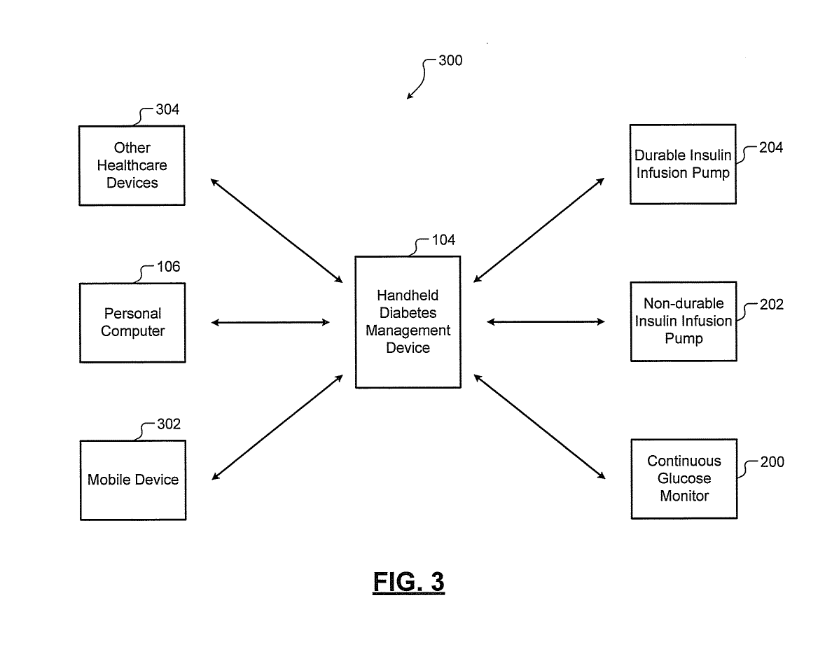

Referring now to FIG. 3, a diabetes management system 300 is shown which can be used by the patient 100 and/or the health care professional 102. The system 300 can include one or more of the following devices: the diabetes management device 104, the CGM 200, the insulin pump 204, a mobile device 302, the diabetes management software executed on the computer 106, and one or more other health care devices 304.

The diabetes management device 104 can be configured as a system “hub” and communicate with one or more of the other devices of the system 300. The insulin pump 204, the mobile device 302, or another suitable device can alternatively serve as the system hub. Communication between various devices in the system 300 can be performed using wireless interfaces (e.g., Bluetooth) and/or wired interfaces (e.g., USB). Communication protocols used by these devices can include protocols compliant with the IEEE 11073 standard as extended using guidelines provided by Continua Health Alliance Design Guidelines. Further, health care records systems such as Microsoft HealthVault™ and Google Health™ can be used by the patient 100 and the health care professional 102 to exchange information.

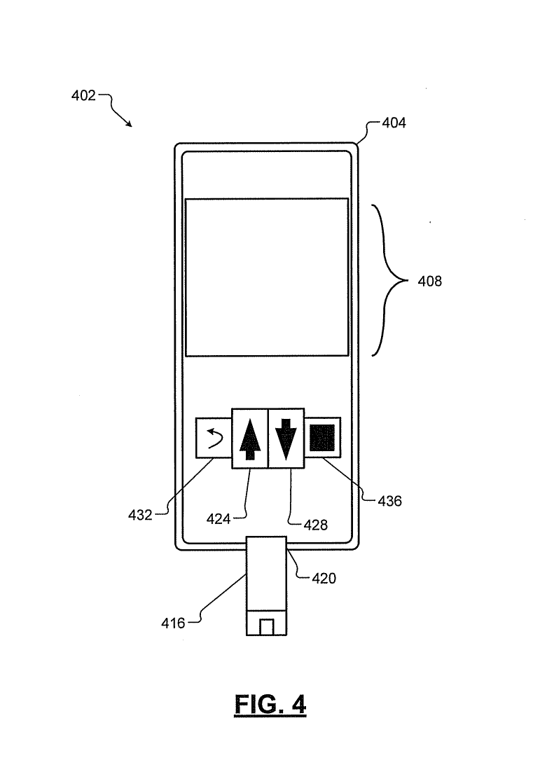

Referring now to FIG. 4, a high level illustration of an example embodiment of a (handheld) diabetes management device 402 is presented. The diabetes management device 402 includes, among other things, a housing 404, a display 408, and a bG test strip port 420. The diabetes management device 402 may optionally include a bG test strip drum (not shown). The bG test strip drum may house a plurality of bG test strips, such as bG test strip 416.

The diabetes management device 402 also includes user interface switches/buttons, such as up button 424, down button 428, back button 432, and enter button 436. The user interface switches/buttons can also include other buttons or switches, for example, ON/OFF switches and/or one or more other switches/buttons or other types of control devices that a patient can use to control functions/operations of the diabetes management device 402.

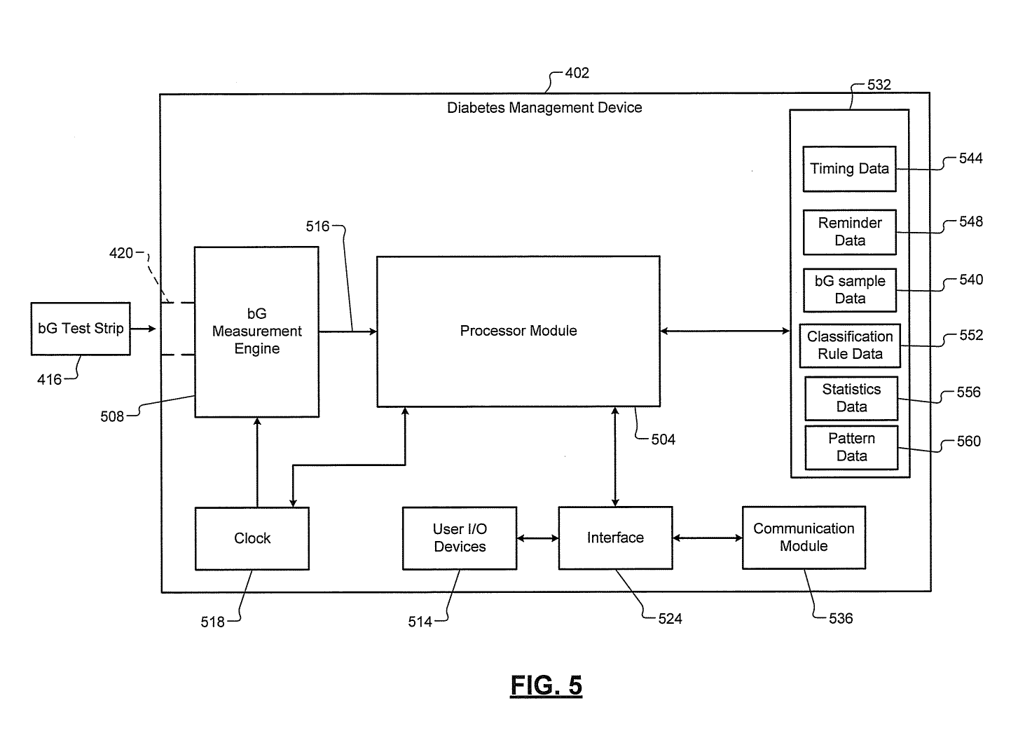

The bG test strip 416 can be inserted into the bG test strip port 420 by a user. The bG test strip 416 is shown already inserted into the bG test strip port 420 in the example of FIG. 4 and not yet inserted into the bG test strip port 420 in the example of FIG. 5. The display 408 of the diabetes management device 402 may be a non-touch screen display, such as a dot-matrix display. Various information may be selectively displayed on the display 408. For example, a bG level may be displayed on the display 408 when a measurement of bG is made in response to insertion of a bG test strip having a blood sample thereon.

Referring now to FIG. 5, a functional block diagram of an example implementation of the diabetes management device 402 is presented. The diabetes management device 402 includes a processor module (e.g., a microprocessor based subsystem) 504 that receives information from a bG measurement engine 508.

The bG measurement engine 508 reads (measures) bG levels of blood samples present on bG test strips inserted into the bG test strip port 420. For example, the bG measurement engine 508 measures a bG level of the bG test strip 416 when inserted into the bG test strip port 420. The bG measurement engine 508 can be located adjacent the bG test strip port 420. The bG measurement engine 508 generates bG sample data 516 based on its reading of a blood sample present on a bG test strip. Among other information, the bG sample data 516 includes data indicative of the bG level of a bodily fluid sample on the bG test strip.

The bG measurement engine 508 can also generate the bG sample data 516 to include the date and time when the bG test strip 416 was read. In other words, the bG measurement engine 508 can include a time stamp with the bG sample data 516. In various implementations, the processor module 504 can selectively time stamp the bG sample data 516. A clock 518 may track the present day, date, and time. Time stamps may include data indicative of the date and time and may also include the day.

The processor module 504 can receive user input and output information to a user via one or more user input/output (I/O) devices 514, such as the buttons 424-436 and the display 408. One or more I/O interfaces, such as I/O interface 524, facilitate communication between the user I/O devices 514 and the processor module 504. The I/O interfaces may also facilitate communication between the processor module 504 and one or more communication modules, such as communication module 536. The communication module 536 may include a wireless transceiver and communicate (transmit and receive) wirelessly via one or more antennas.

The diabetes management device 402 includes a computer readable medium 532, such as memory and/or one or more other suitable computer readable mediums. Various data may be stored in the computer readable medium 532, such as bG sample data 540 and other types of data, as discussed further below. The bG sample data 540 may include bG sample data generated by the bG measurement engine 508, such as the bG sample data 516, and the associated time stamp. The bG sample data 540 may also include other types of data related to blood samples.

Blood samples provided regularly at approximately the same time(s) and/or around the same daily event(s) yield better results in terms of bG management than blood samples provided randomly. For example, a bG management strategy generated based on blood samples provided at the same daily event(s) may be more accurate than a bG management strategy generated based on various blood samples taken under different conditions on various days. This is because a user's bG level constantly changes throughout each day and changes with food intake, exercise, stress, etc. Measurements taken at or around the same daily event(s) can be used to provide better suggestions as to what actions to take before and after those daily event(s).

Timing data 544 includes times for daily events and times/periods for other events. FIG. 6 includes an example illustration of contents of the timing data 544. Referring now to FIGS. 5 and 6, the daily events may include, for example, waking up/rising, breakfast, lunch, dinner, and bed. The timing data 544 therefore includes data indicative of a waking time 604 for waking up/rising, a breakfast time 608 for breakfast, a lunch time 612 for lunch, a dinner time 616 for dinner, and a bed time 620 for bed time.

The other events may include, for example, post-meal blood samples and hypoglycemic followup blood samples. The timing data 544 therefore includes data indicative of a post-meal period 624 for post-meal blood samples and a hypo followup period 628 for hypoglycemic followup blood samples. In various implementations, the timing data 544 may include a post-meal period for breakfast, a post-meal period for lunch, and a post-meal period for dinner. A blood sample may be deemed hypoglycemic when its bG level is less than a predetermined hypoglycemic bG value. A hypoglycemic followup blood sample may refer to a measurement taken following a blood sample deemed hypoglycemic.

The waking time 604, the breakfast time 608, the lunch time 612, the dinner time 616, the bed time 620, the post-meal period 624, and the hypo followup period 628 are predetermined values and may be set, for example, by a manufacturer of the diabetes management device 402. For example only, the waking time 604 may be set to approximately 7:00 am, the breakfast time 608 may be set to approximately 8:00 am, the lunch time 612 may be set to approximately 12:00 pm, the dinner time 616 may be set to approximately 5:00 pm, the bed time 620 may be set to approximately 9:00 pm, the post-meal period 624 may be set to approximately 2 hours, and the hypo followup period 628 may be set to approximately 15 minutes.

The waking time 604, the breakfast time 608, the lunch time 612, the dinner time 616, the bed time 620, the post-meal period 624, and/or the hypo followup period 628 can be adjusted by a user, such as via one or more of the buttons 424-436. The waking time 604, the breakfast time 608, the lunch time 612, the dinner time 616, the bed time 620, the post-meal period 624, and/or the hypo followup period 628 may be adjusted, for example, to more accurately reflect when those events take place in the user's daily life.

The diabetes management device 402 may remind the user to input a blood sample for one or more of the events. For example only, the processor module 504 may display a reminder on to input a blood sample on the display 408 and/or generate one or more other alerts (e.g., audible, visual, and/or tactile) to remind the user to input a blood sample for an event.

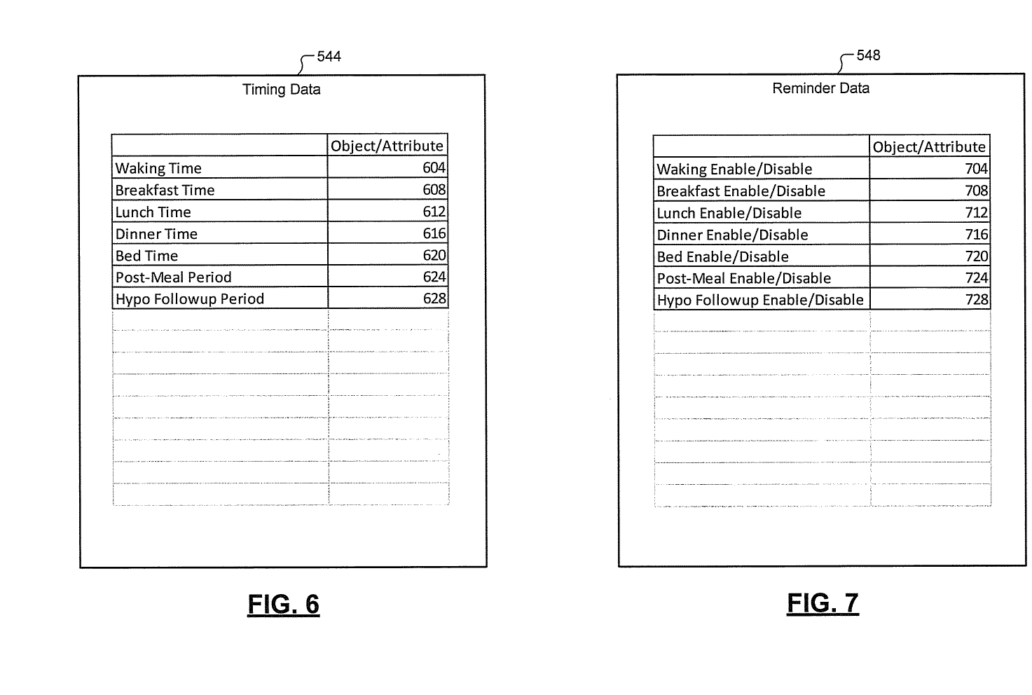

Reminder data 548 includes data indicating whether to remind the user for each of the events. FIG. 7 includes an example illustration of contents of the reminder data 548. Referring now to FIGS. 5-7, the reminder data 548 includes waking enable/disable data 704 that is associated with/related to the waking time 604. The waking enable/disable data 704 indicates whether to remind the user to input a blood sample at the waking time 604.

The reminder data 548 also includes breakfast enable/disable data 708 that is associated with/related to the breakfast time 608. The breakfast enable/disable data 708 indicates whether to remind the user to input a blood sample at the breakfast time 608, before consuming breakfast. Lunch enable/disable data 712 is associated with/related to the lunch time 612. The lunch enable/disable data 712 indicates whether to remind the user to input a blood sample at the lunch time 612, before consuming lunch. Dinner enable/disable data 716 is associated with/related to the dinner time 616. The dinner enable/disable data 716 indicates whether to remind the user to input a blood sample at the dinner time 616, before consuming dinner. Bed enable/disable data 720 is associated with/related to the bed time 620. The bed enable/disable data 720 indicates whether to remind the user to input a blood sample at the bed time 620.

Post-meal enable/disable data 724 is associated with/related to the post-meal period 624. The post-meal enable/disable data 724 indicates whether to remind the user to input a blood sample the post-meal period 624 after a blood sample is received for (or the time associated with) a given meal, such as breakfast, lunch, or dinner. Hypo followup enable/disable data 728 is associated with/related to the hypo followup period 628. The hypo followup enable/disable data 728 indicates whether to remind the user to input a blood sample the hypo followup period 628 after a blood sample is received that is deemed hypoglycemic.

The waking enable/disable data 704, the breakfast enable/disable data 708, the lunch enable/disable data 712, the dinner enable/disable data 716, bed enable/disable data 720, the post-meal enable/disable data 724, and the hypo followup enable/disable data 728 are predetermined values and may be set, for example, by the manufacturer of the diabetes management device 402. However, the waking enable/disable data 704, the breakfast enable/disable data 708, the lunch enable/disable data 712, the dinner enable/disable data 716, bed enable/disable data 720, the post-meal enable/disable data 724, and the hypo followup enable/disable data 728 can be adjusted by a user, such as via one or more of the buttons 424-436.

The waking enable/disable data 704, the breakfast enable/disable data 708, the lunch enable/disable data 712, the dinner enable/disable data 716, the bed enable/disable data 720, the post-meal enable/disable data 724, and the hypo followup enable/disable data 728 may each include other data. For example, a time stamp may be included when that piece of enable/disable data was set to disable generation of the associated reminder.

The processor module 504 selectively generates reminders to input a blood sample for the events at the associated times (as indicated in the timing data 544) based on whether reminders for the events are enabled or disabled (as indicated in the reminder data 548), respectively. For example, when the waking enable/disable data 704 is set to enable waking reminders, the processor module 504 generates a reminder to provide a blood sample at the waking time 604.

When the breakfast enable/disable data 708 is set to enable breakfast reminders, the processor module 504 generates a reminder to provide a blood sample at the breakfast time 608. When the lunch enable/disable data 712 is set to enable lunch reminders, the processor module 504 generates a reminder to provide a blood sample at the lunch time 612. When the dinner enable/disable data 716 is set to enable dinner reminders, the processor module 504 generates a reminder to provide a blood sample at the dinner time 616. When the bed enable/disable data 720 is set to enable bed reminders, the processor module 504 generates a reminder to provide a blood sample at the bed time 620.

When the post-meal enable/disable data 724 is set to enable post-meal reminders, the processor module 504 generates a reminder to provide a blood sample the post-meal period 624 after the one of the times 608-616 for that meal or the post-meal period after receipt of a blood sample for that meal. When the hypo followup enable/disable data 728 is set to enable reminders following hypoglycemic blood samples, the processor module 504 generates a reminder to provide a blood sample the hypo followup period 628 after receipt of a hypoglycemic blood sample. As described above, the reminder may include, for example, a reminder to input a blood sample displayed on the display 408 and/or one or more other alerts (e.g., audible, visual, and/or tactile) to remind the user to input a blood sample.

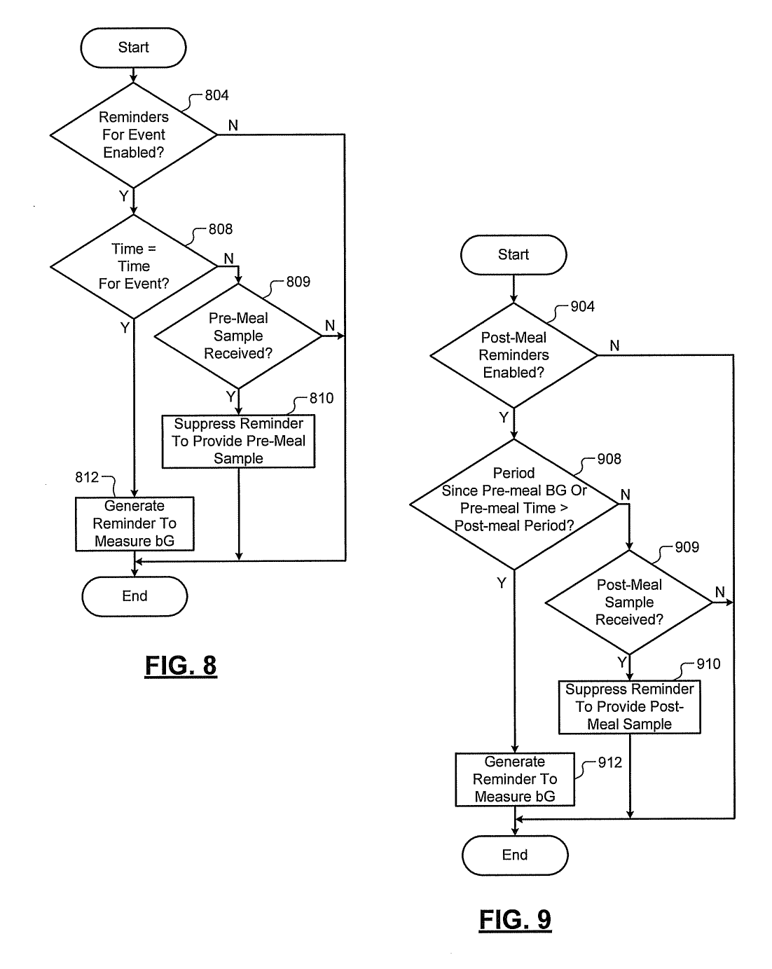

FIG. 8 is a flowchart depicting an example method of generating a reminder to measure bG for an event. While the event will be discussed as waking, FIG. 8 is also applicable to generating a reminder to measure bG for other events, such as for breakfast, lunch, dinner, and bed. At 804, the processor module 504 may determine whether reminders for waking are enabled. The processor module 504 may determine whether reminders for waking are enabled based on the waking enable/disable data 704. If 804 is true, control may continue with 808. If 804 is false, control may end.

At 808, the processor module 504 retrieves the waking time 604 and the present time, and the processor module 504 determines whether the present time is the same as the waking time 604. If 808 is false, control may continue with 809. If 808 is true, the processor module 504 generates a reminder to measure bG level at 812, and control may end. As discussed above, the reminder may include, for example, displaying a reminder to measure bG level on the display 408 and/or generating one or more other suitable types of reminders, such as audio, visual, and/or tactile alerts.

At 809, the processor module 504 determines whether a blood sample has already been provided for the waking time 604. If 809 is true, the processor module 504 suppresses generation of the reminder to measure bG level for that waking time 604 at 810, and control may end. If 809 is false, control may end. While control is shown and discussed as ending, FIG. 8 may be illustrative of one control loop, and control loops may be performed at a predetermined rate.

FIG. 9 is a flowchart depicting an example method of generating a reminder to measure bG after a meal (i.e., post-meal). At 904, the processor module 504 may determine whether reminders for post-meal blood samples are enabled. The processor module 504 may determine whether reminders for post-meal blood samples are enabled based on the post-meal enable/disable data 724. If 904 is true, control may continue with 908. If 904 is false, control may end.

At 908, the processor module 504 may determine whether the period between a time that a meal began and the present time is greater than the post-meal period 624. The present time may be stored as the time that the meal began when, for example, the user inputs an indicator of the beginning of the meal, such as via one or more of the user input devices 514, such as the buttons 424-436. Additionally or alternatively, the processor module 504 may determine whether the period between the time when a blood sample provided for the meal (a pre-meal measurement) and the present time is greater than the post-meal period 624 at 908. If 908 is false, control may continue with 909. If 908 is true, the processor module 504 generates a reminder to measure bG level at 912, and control may end.

At 909, the processor module 504 determines whether a blood sample has already been provided after the meal. If 909 is true, the processor module 504 suppresses generation of the reminder to measure bG level after that meal at 910, and control may end. If 909 is false, control may end. While control is shown and discussed as ending, FIG. 9 may be illustrative of one control loop, and control loops may be performed at a predetermined rate.

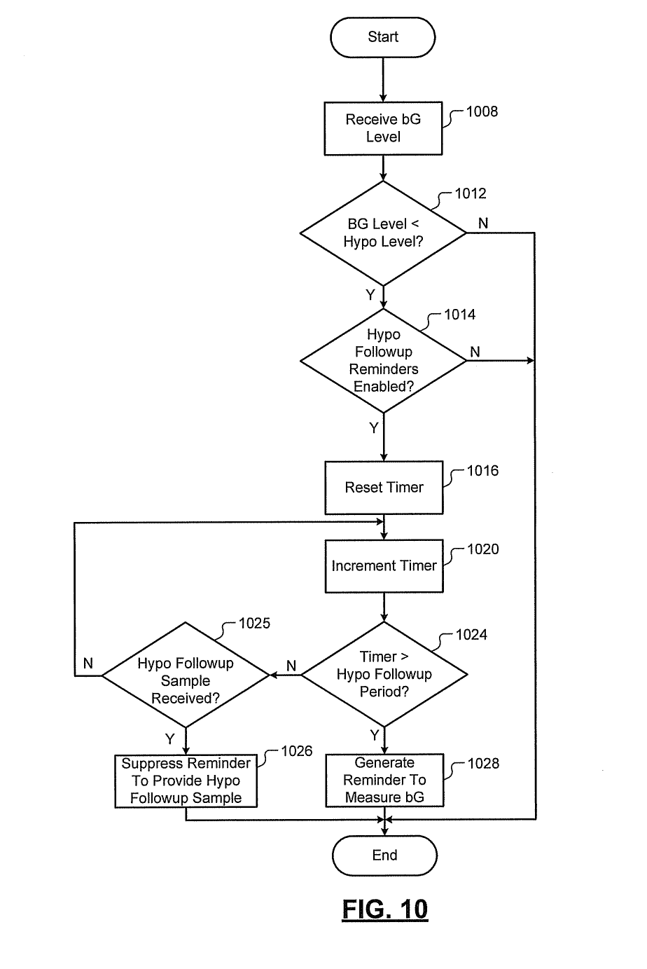

FIG. 10 includes an example method of generating a reminder to measure bG after a hypoglycemic blood sample is provided. At 1008, the processor module 504 receives the bG level of a blood sample present on a bG test strip. At 1012, the processor module 504 determines whether the bG level of the blood sample is less than the predetermined hypoglycemic bG level. If 1012 is true, control may continue with 1014. If 1012 is false, control may end.

At 1014, the processor module 504 may determine whether reminders for followup measurements after hypoglycemic blood samples are enabled. The processor module 504 may determine whether reminders for followup measurements after hypoglycemic blood samples are enabled based on the hypo followup enable/disable data 728. If 1014 is true, control may continue with 1016. If 1014 is false, control may end.

At 1016, the processor module 504 may reset a timer. The processor module 504 may increment the timer at 1020. The timer tracks the period since the hypoglycemic blood sample was received. At 1024, the processor module 504 determines whether the timer is greater than the hypo followup period 628. If 1024 is false, control may transfer to 1025. If 1024 is true, the processor module 504 generates a reminder to measure bG at 1028, and control may end.

At 1025, the processor module 504 determines whether a blood sample has already been provided following the hypoglycemic blood sample. If 1025 is true, the processor module 504 suppresses generation of the reminder to measure bG level following the hypoglycemic measurement at 1026, and control may end. Of course, if that bG level is hypoglycemic too, the process may continue (e.g., return to 1016). If 1025 is false, control may transfer to 1020. While control is shown and discussed as ending, FIG. 10 may be illustrative of one control loop, and control loops may be performed at a predetermined rate.

Reminding the user to provide blood samples regularly may help the user to provide blood samples more consistently. Blood samples provided more regularly may be better analyzed for patterns/trends, and blood samples provided more regularly may be used to more accurately provide suggestions as to actions to take at various points of a day to stabilize the user's bG level.

Referring back to FIG. 5, the processor module 504 may analyze the reminder data 548 determine whether the reminders are disabled. When the period between when the reminders were disabled is greater than a predetermined notification period, the processor module 504 may selectively display a notification on the display 408. The notification may indicate that the diabetes management device 402 can generate reminders for the events and prompt the user to provide input as to whether to enable or disable reminders for the events.

The processor module 504 selectively updates the data 704-728 based on the user input and updates the data 704-728 based on the present date and time if the user chooses to continue disabling the reminders. For example only, the predetermined notification period may be approximately 90 days or another suitable period.

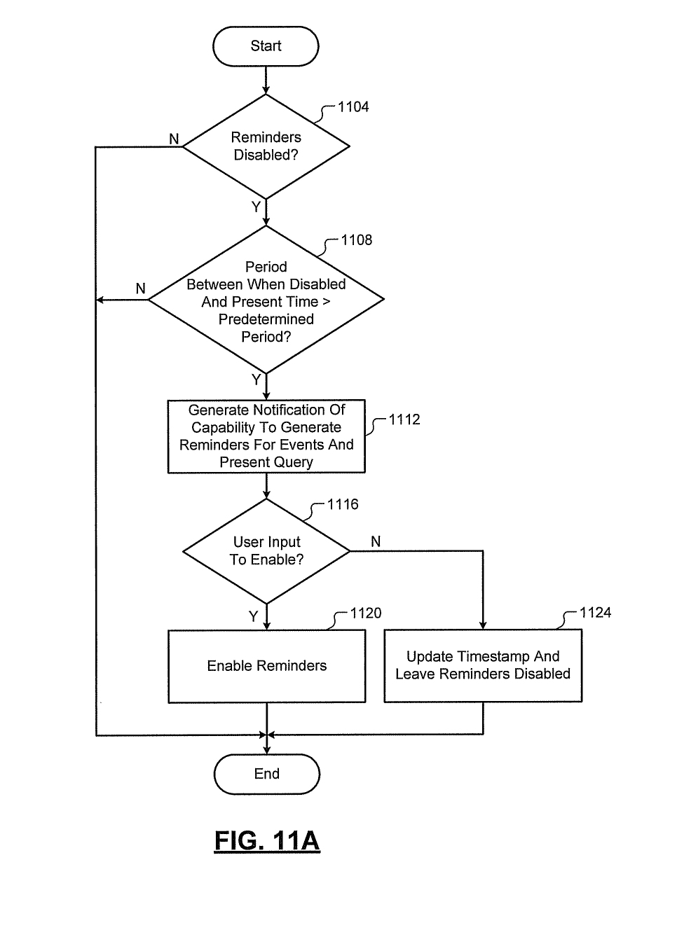

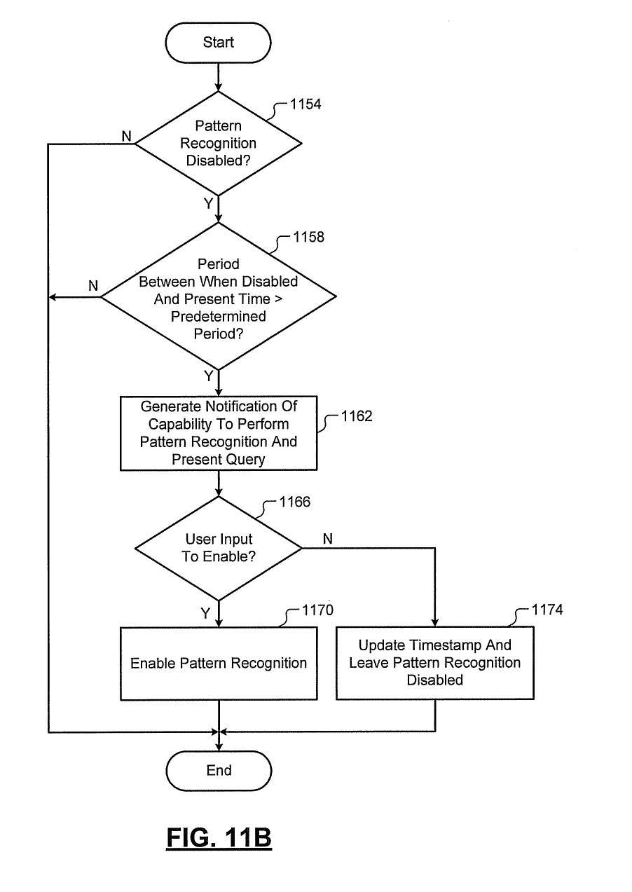

FIG. 11A is a flowchart depicting an example method of notifying a user that the diabetes management device 402 is capable of providing reminders for the events. At 1104, the processor module 504 may determine whether the reminders are disabled. The processor module 504 may determine whether the reminders are disabled based on the reminder data 548. If 1104 is true, control may continue with 1108. If 1104 is false, control may end.

At 1108, the processor module 504 may determine whether the period between the date and time when the reminders were disabled and the present date and time is greater than the predetermined notification period. If 1108 is false, control may end. If 1108 is true, control may continue with 1112.

At 1112, the processor module 504 generates the notification that the diabetes management device 402 is capable of reminding the user to measure their bG level for each of the events. The notification may include, for example, a visual notification on the display 408. The processor module 504 may also query the user at 1112 as to whether the user desires the reminders for the events to be enabled.

At 1116, the processor module 504 may determine whether the user's response to the query indicates that the user desires to enable the reminders. If 1116 is true (indicating that the user desired to enable the reminders), the processor module 504 may update the reminder data 548 to enable the reminders for the events at 1120, and control may end. If 1116 is false (indicating that the user desired to maintain the reminders disabled), the processor module 504 stores the present date and time at 1124, and control may end. The notification may be generated again in the future (the predetermined notification period after the stored date and time) if the reminders are not first enabled. While control is shown and discussed as ending, FIG. 11A may be illustrative of one control loop, and control loops may be performed at a predetermined rate.

FIG. 11B is a flowchart depicting an example method of notifying a user that the diabetes management device 402 is capable of performing pattern recognition in blood samples. At 1154, the processor module 504 may determine whether pattern recognition is disabled. The user can enable and disable pattern recognition via one or more of the user input devices 514. Pattern recognition is described in further detail below. The processor module 504 may determine whether pattern recognition is disabled based on pattern data 560. If 1154 is true, control may continue with 1158. If 1154 is false, control may end.

At 1158, the processor module 504 may determine whether the period between the date and time when pattern recognition was disabled and the present date and time is greater than the predetermined notification period. If 1158 is false, control may end. If 1158 is true, control may continue with 1162.

At 1162, the processor module 504 generates the notification that the diabetes management device 402 is capable of performing pattern recognition. The notification may include, for example, a visual notification on the display 408. The processor module 504 may also query the user at 1162 as to whether the user desires pattern recognition to be enabled.

At 1166, the processor module 504 may determine whether the user's response to the query indicates that the user desires to enable pattern recognition. If 1166 is true (indicating that the user desired to enable pattern recognition), the processor module 504 may update the pattern data 560 to enable pattern recognition at 1170, and control may end. If 1166 is false (indicating that the user desired to maintain pattern recognition disabled), the processor module 504 stores the present date and time at 1174, and control may end. The notification may be generated again in the future (the predetermined notification period after the stored date and time) if pattern recognition is not first enabled. While control is shown and discussed as ending, FIG. 11B may be illustrative of one control loop, and control loops may be performed at a predetermined rate.

Referring back to FIG. 5, the processor module 504 also selectively classifies the bG sample data 516 as one of a waking measurement, a pre-breakfast measurement, a post-breakfast measurement, a pre-lunch measurement, a post-lunch measurement, a pre-dinner measurement, a post-dinner measurement, or a bed time measurement. Waking measurements may also be referred to as fasting measurements. However, fasting measurements may also include measurements taken when a period of fasting occurred prior to measurement. The processor module 504 classifies the bG sample data 516 based on the timestamp included in the bG sample data 516 and the timing data 544 associated with the events. The processor module 504 may update the bG sample data 516 to include an indicator of the classification or may store an indicator of the classification and relate the indicator with the bG sample data 516.

The processor module 504 performs this process for each blood sample measured by the bG measurement engine 508. The processor module 504 can select bG sample data associated with one or more of the events based on the classifications, as discussed below. The processor module 504 determines the classification for each blood sample using classification rule data 552. The classification rule data 552 includes data indicating what data to use and rules for how to classify bG sample data.

For example, the processor module 504 may classify the bG sample data 516 as a waking measurement when the timestamp of the bG sample data 516 is within a predetermined period before or within a predetermined time period around the waking time 604. The processor module 504 may classify the bG sample data 516 as a bed time measurement when the timestamp of the bG sample data 516 is within a predetermined period after or within a predetermined time period around the bed time 620.

The processor module 504 may classify the bG sample data 516 as a pre-meal measurement of a meal when the timestamp of the bG sample data 516 is within a predetermined time window around the one of the times 608-616 associated with the meal. For example, the processor module 504 may classify the bG sample data 516 as a pre-breakfast measurement when the timestamp of the bG sample data 516 is within a predetermined time window around the breakfast time 608. The processor module 504 may classify the bG sample data 516 as a pre-lunch measurement when the timestamp of the bG sample data 516 is within a predetermined time window around the lunch time 612. The processor module 504 may classify the bG sample data 516 as a pre-dinner measurement when the timestamp of the bG sample data 516 is within a predetermined time window around the dinner time 616.

The processor module 504 may classify the bG sample data 516 as a post-meal measurement of a meal when the timestamp of the bG sample data 516 is within the post-meal period 624 after the timestamp of another piece of bG sample data that is classified as a pre-meal sample of that meal. For example, the processor module 504 may classify the bG sample data 516 as a post-breakfast measurement when the timestamp of the bG sample data 516 is within the post-meal period 624 after the timestamp of a second piece of bG sample data that is classified as a pre-breakfast measurement. The processor module 504 may classify the bG sample data 516 as a post-lunch measurement when the timestamp of the bG sample data 516 is within the post-meal period 624 after the timestamp of a second piece of bG sample data that is classified as a pre-lunch measurement. The processor module 504 may classify the bG sample data 516 as a post-dinner measurement when the timestamp of the bG sample data 516 is within the post-meal period 624 after the timestamp of a second piece of bG sample data that is classified as a pre-dinner measurement.

The processor module 504 may prompt the user to select one of the classifications for bG sample data that could be classified in multiple different ways and set the classification for the bG sample data based on the user input. The processor module 504 may also selectively update the classification determined for bG sample data based on use input indicative of one of the classifications. In this manner, the user can overwrite the classification determined for bG sample data.

The automated classification of bG sample data performed by the processor module 504 may ensure that bG sample data is classified in the event that the user does not provide the classification. The automated classification of bG sample data performed by the processor module 504 may also provide for less frequent user classifications.

The processor module 504 may determine the classification for the bG sample data 516 and store the indicator of the classification before displaying the bG level of the bG sample data 516. The processor module 504 may determine the classification and store the indicator, for example, before a blood sample is applied to a test strip or after the bG level is determined but before the bG level is displayed. Classifying the bG sample data 516 and storing the indicator before displaying the bG level may make testing more hygienic as the user may not need to self-classify bG sample data at a time when the user may or may not have blood on a finger used to provide the blood sample.

The processor module 504 selectively performs statistical analysis functions based on the stored bG sample data 540. The processor module 504 may perform a statistical analysis and display one or more results of the statistical analysis on the display 408, for example, when the user requests performance of the statistical analysis.

The processor module 504 performs statistical analyses using statistics data 556. The statistics data 556 includes data indicating which bG levels stored in the computer readable medium 532 to use and rules for performing the statistical analyses. A statistical analysis may be performed without regard to the classification of the stored bG levels used or using stored bG levels selected for having one or more of the classifications.

An example statistical analysis includes determining a low blood glucose index (LBGI) value for the user. The LBGI value corresponds to an amount of risk that the user will experience hypoglycemia during a predetermined period in the future, such as during the next three to six months. The user's risk of hypoglycemia during the predetermined period may increase as the LBGI value increases and vice versa.

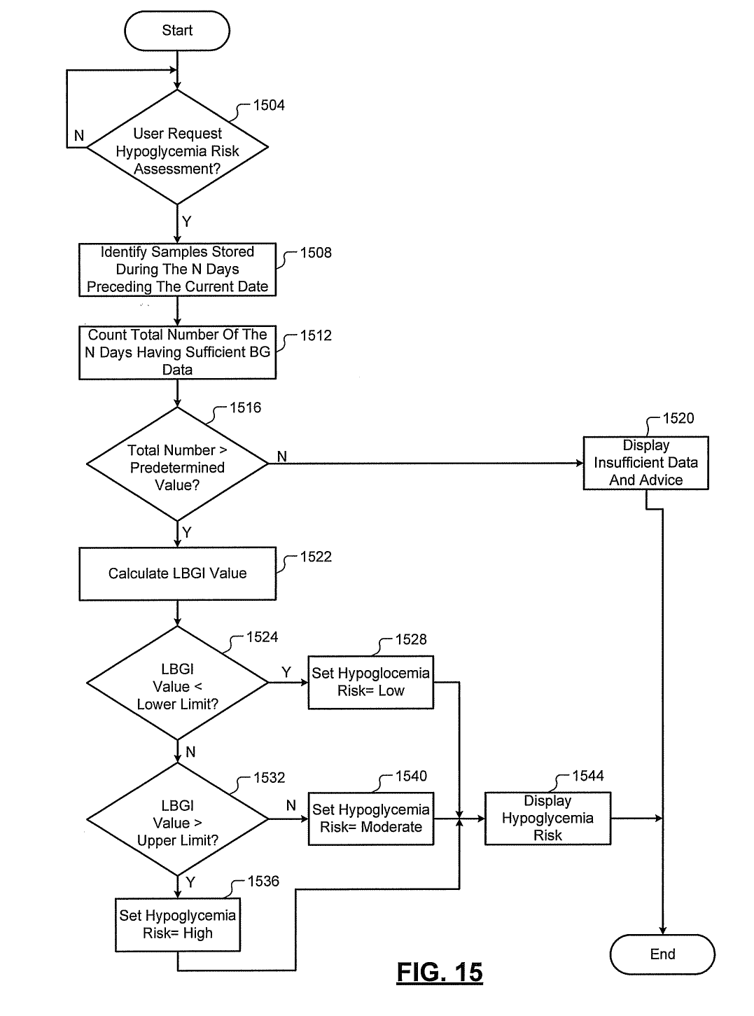

Another example statistical analysis includes determining a high blood glucose index (HBGI) value for the user. The HBGI value corresponds to an amount of risk that the user will experience hyperglycemia during the predetermined period in the future, such as during the next three to six months. The user's risk of hyperglycemia during the predetermined period may increase as the HBGI value increases and vice versa. Determination and use of the LBGI and HBGI values are discussed further below in conjunction with the examples of FIG. 15-17.

Additionally or alternatively, the processor module 504 may determine an average of the stored bG levels. Additionally or alternatively, the processor module 504 may determine a standard deviation of the stored bG levels. Additionally or alternatively, the processor module 504 may determine a ratio or percentage of the stored bG levels that are less than the predetermined hypoglycemic level, a ratio or percentage of the stored bG levels that are greater than the predetermined hyperglycemic level, and/or a ratio or percentage of the bG levels stored that are between a target higher bG level and a target lower bG level. Additionally or alternatively, the processor module 504 may determine a frequency of hypoglycemic blood samples and/or a frequency of hyperglycemic blood samples based on the stored bG levels.

The processor module 504 may also selectively display more detailed information for the stored bG levels used to perform a statistical analysis on the display 408. For example, the processor module 504 may selectively display the time and date, the bG level, and the classification of bG sample data used in performing a statistical analysis. The processor module 504 may display the more detailed information, for example, in response to user input requesting that the more detailed information be displayed.

The processor module 504 also selectively performs pattern recognition functions based on the stored bG sample data 540. The processor module 504 may perform pattern recognition, for example, each time a blood sample is provided.

The processor module 504 performs pattern recognition using pattern data 560. The pattern data 560 includes data indicating which bG sample data stored in the computer readable medium 532 to use (select) and rules for identifying patterns in the stored bG sample data. Pattern recognition may be performed, for example, using stored bG sample data having the same classification as the most recently received blood sample.

The processor module 504 selects stored bG sample data that is classified the same way as the most recently received blood sample. The processor module 504 may select, for example, stored bG sample data that has the same classification as the most recently received blood sample and that was received within the most recent predetermined period (e.g., 3-7 days). As an example of the selection, when a pre-lunch sample is received, the processor module 504 may select bG sample data for blood samples classified as pre-lunch samples that were received within the last 7 days.

The processor module 504 determines whether a pattern is present based on whether the selected bG sample data satisfies predetermined pattern criteria. For example, the processor module 504 may determine that a high pre-meal bG pattern is present when more than a first predetermined number (e.g., at least 3 or 4 when a period of 7 days is used) of pieces of the selected bG sample data (the bG sample data selected as having that pre-meal classification) have bG levels that are greater than a first predetermined bG value. The meal can be breakfast, lunch, dinner, or optionally a fourth-meal, such as tea. The processor module 504 may determine that a low pre-meal bG pattern is present when more than a second predetermined number (e.g., at least 2 when a period of 7 days is used) of pieces of the selected bG sample data (the bG sample data selected as having that pre-meal classification) have bG levels that are less than a second predetermined bG value. As with high pre-meal bG patterns, for low pre-meal bG patterns, the meal can be breakfast, lunch, dinner, or optionally a fourth-meal. The first predetermined bG value is greater than the second predetermined bG value. The processor module 504 may determine that a high post-meal bG pattern is present when more than the first predetermined number (e.g., at least 3 or 4 when a period of 7 days is used) of pieces of the selected bG sample data (the bG sample data selected as having that pre-meal classification) have bG levels that are greater than a third predetermined bG value. The meal can be breakfast, lunch, dinner, or optionally a fourth-meal, such as tea. The processor module 504 may determine that a low post-meal bG pattern is present when more than the second predetermined number (e.g., at least 2 when a period of 7 days is used) of pieces of the selected bG sample data (the bG sample data selected as having that pre-meal classification) have bG levels that are less than a fourth predetermined bG value. As with high post-meal bG patterns, for low post-meal bG patterns, the meal can be breakfast, lunch, dinner, or optionally a fourth-meal. The third predetermined bG value is greater than the fourth predetermined bG value. When a pattern is recognized, the processor module 504 stores an indicator of the recognized pattern and the selected bG sample data based upon which the pattern was recognized in the computer readable medium 532, such as in the pattern data 560.

The processor module 504 selectively displays recognized patterns on the display 408. When a pattern is recognized based on the selected bG sample data, the processor module 504 displays an indication of the pattern on the display 408. For example, the processor module 504 may display an indication that a high or low pre- or post-meal pattern is present when the high or low pre- or post-meal pattern is recognized.

The processor module 504 may also query the user to input an acknowledgement of the recognized pattern and to view details of the bG sample data based upon which the pattern was recognized. In response to user input indicative of an acknowledgement of the recognized pattern, the processor module 504 displays details of the selected bG sample data based on which the pattern was recognized. The details may include, for example, date and time of measurement of a sample, bG level, the associated target bG level, and other suitable details. The processor module 504 may display the details, for example, one piece of bG sample data at a time.

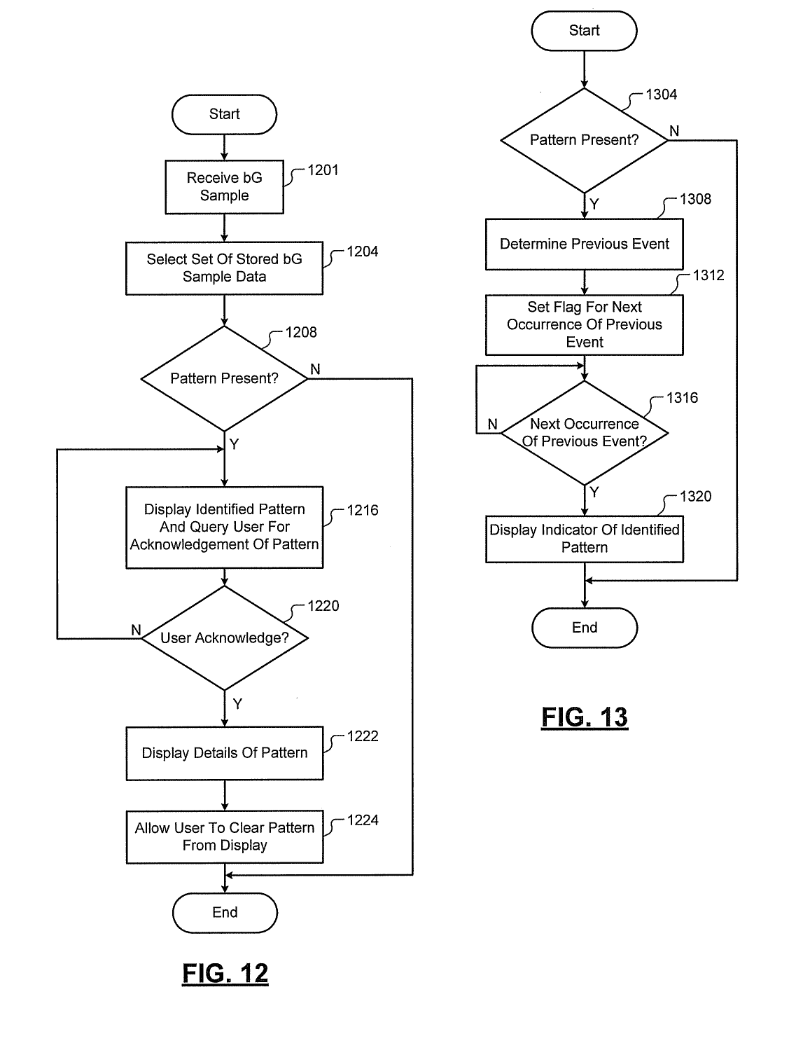

FIG. 12 includes a flowchart depicting an example method of identifying and displaying a pattern in bG sample data. At 1202, the diabetes management device 402 receives a blood sample. The processor module 504 may determine a classification for the blood sample or the classification of the blood sample may be set based on user input indicative of the classification.

At 1204, the processor module 504 selects a set of stored bG sample data. The processor module 504 may, for example, select the set of stored bG sample data based on classification, time stamps, and/or other suitable parameters. For example, the processor module 504 may select stored bG sample data having the same classification as the blood sample received (at 1202) and received within the last predetermined period (e.g., 7 days). For clarity, it should be noted that the bG sample data associated with the blood sample received at 1202 is one of the pieces of bG sample data that is selected.

At 1208, the processor module 504 determines whether a pattern is present based on the selected set of stored bG sample data. If 1208 is true, the processor module 504 stores an indicator of the recognized pattern in the computer readable medium 532 and continues with 1216. If 1208 is false, control may end. At 1216, the processor module 504 displays identified pattern on the display 408. The processor module 504 also queries the user at 1216 to provide input indicating an acknowledgement of the identified pattern.

At 1220, the processor module 504 determines whether user input indicative of an acknowledgement of the presence of the identified pattern has been received. If 1220 is false, control returns to 1216, and the processor module 504 continues to display the identified pattern. If 1220 is true, the processor module 504 may continue with 1222. At 1222, the processor module 504 selectively displays details of the selected set of stored bG sample data, such as date and time, bG level, etc. The processor module 504 then allows the user to clear the identified pattern from the display 408 at 1224, and control may end.

Referring back to FIG. 5, when the processor module 504 recognizes the presence of a pattern based on stored bG sample data having one classification, the processor module 504 may identify a daily event preceding the event associated with the classification. For example, when the processor module 504 recognizes the presence of a high or low bG pattern based on pre-lunch samples, the processor module 504 may identify breakfast as a previous event.

The next time that a blood sample is provided for the previous event, the processor module 504 displays an indicator of that recognized pattern at the event associated with the classification. For example, at the breakfast following the lunch when a pattern was recognized, the processor module 504 may display an indicator that a high or low bG pattern was recognized at the previous lunch. In the above example, the high or low bG pattern may be attributable to meal consumption at breakfast. Providing the indication of the recognized pattern at breakfast may help the user adjust his or her breakfast to prevent having a high or low pre-lunch bG level at the following lunch.

FIG. 13 includes a flowchart depicting an example method of, based on recognition of a pattern associated with a daily event, displaying a reminder of the presence of the pattern at an event before that event. At 1304 the processor module 504 determines whether a pattern is present based on a selected set of stored bG sample data, as discussed above in conjunction with FIG. 12. As discussed above, the selected set of bG sample data has one classification and is associated with a daily event, such as lunch. If 1304 is true, control continues with 1308. If 1304 is false, control may end.

At 1308, the processor module 504 determines the daily event that precedes the daily event associated with the selected set of bG sample data based on which the pattern was recognized. For example, if the selected set of bG sample data is associated with lunch, the processor module 504 may determine that the preceding daily event is breakfast. At 1312, the processor module 504 sets a flag or other indicator to display the presence of the recognized pattern at the next instance of the preceding daily event. For example, if the selected set of bG sample data is associated with lunch, the processor module 504 may set the flag or other indicator to display the presence of the recognized pattern at the next breakfast following the lunch where the pattern was recognized.

At 1316, the processor module 504 may determine whether the next occurrence of the preceding daily event (e.g., the next breakfast) is present. For example, the processor module 504 may determine that the next occurrence of the preceding daily event is present at the predetermined time associated with the preceding event and/or based on user input indicative of the next occurrence of the preceding daily event. If 1316 is false, control may remain at 1316. If 1316 is true, control may continue with 1318. At 1318, the order of display of recognized patterns may be prioritized. For example, the processor module 504 may prioritize low bG patterns over high bG patterns, prioritize recognized patterns according to the daily order of the event (e.g., breakfast patterns before lunch patterns, etc.), and/or prioritize newer patterns over older patterns.

The processor module 504 displays an indicator of the recognized pattern(s) associated with the next event at 1320, and control may end. For example, at the next breakfast following recognition of a high or low pre-lunch bG pattern, the processor module 504 may display the presence of the high or low pre-lunch bG pattern. The user can then adjust their breakfast intake in an effort to decrease or increase their pre-lunch bG level of the following lunch.

Referring back to FIG. 5, the processor module 504 may also display previously recognized patterns in response to user input indicative of a desire to view previously recognized patterns. For example, the processor module 504 may generate a list of currently active patterns recognized within a most recent predetermined period and display the list of recognized patterns. The predetermined period may be, for example, 7 days or another suitable period.

Based on user input selecting one of the patterns from the list, the processor module 504 may display details of the stored bG sample data underlying the selected one of the patterns. The processor module 504 also prioritizes the order in which recognized patterns are displayed. For example, the processor module 504 displays low bG patterns before high bG patterns, patterns for earlier daily events before patterns for later daily events (e.g., breakfast patterns before lunch patterns), and/or newer patterns before older patterns.

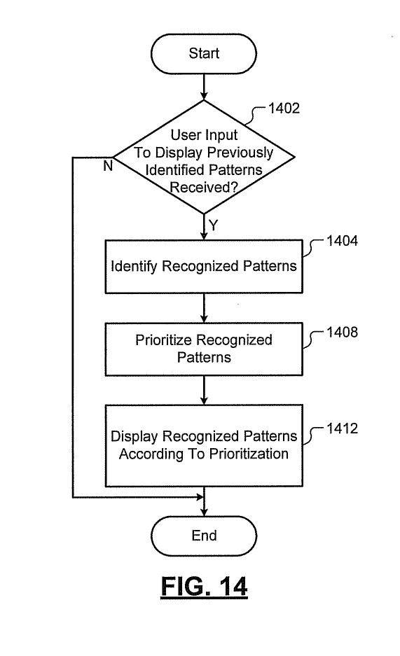

FIG. 14 includes a flowchart depicting an example method of displaying previously recognized patterns in bG sample data. At 1402, the processor module 504 may determine whether user input has been received requesting that previously identified patterns be displayed. If 1402 is true, control continues with 1404. If 1402 is false, control may end.

At 1404, the processor module 504 identifies previously recognized patterns. For example, the processor module 504 may identify patterns recognized within the last predetermined period, such as 3 months, 6 months, 9 months, 1 year, or another suitable period. At 1408, the processor module 504 prioritizes the previously recognized patterns for display.

At 1412, the processor module 504 displays the list of recognized patterns on the display 408 according to the prioritization. Based on user input selecting one of the patterns from the list, the processor module 504 may display details of the stored bG sample data underlying the selected one of the patterns. The processor module 504 may display, for example, the time and date of underlying blood samples, the bG levels of underlying blood samples, and other suitable data.

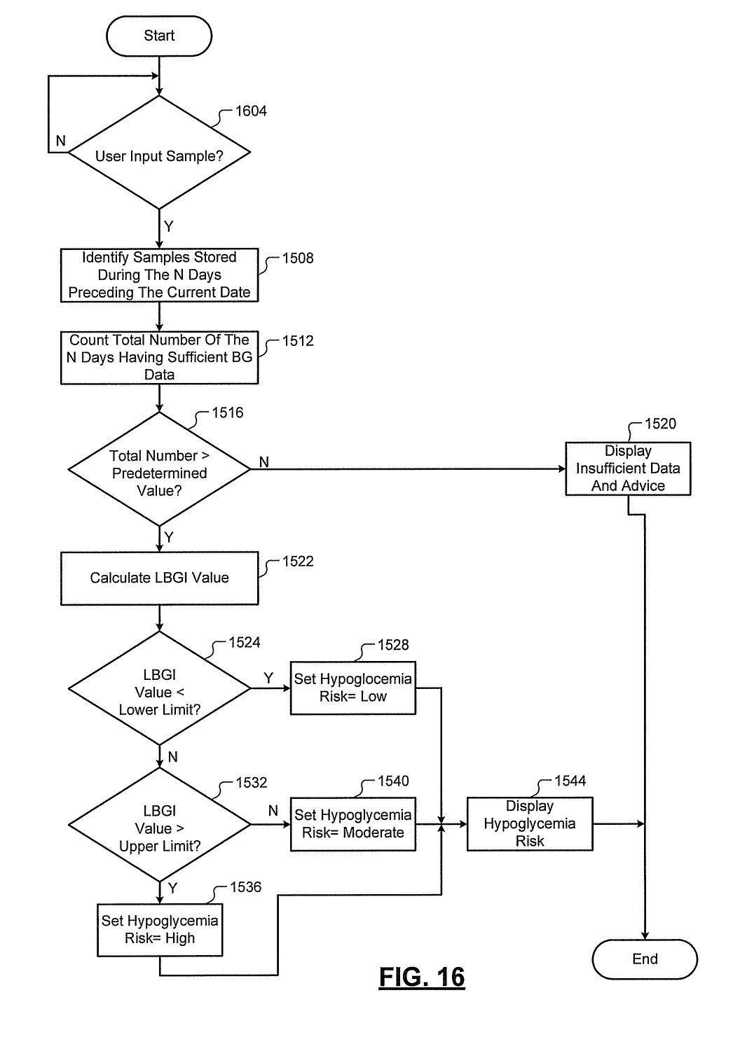

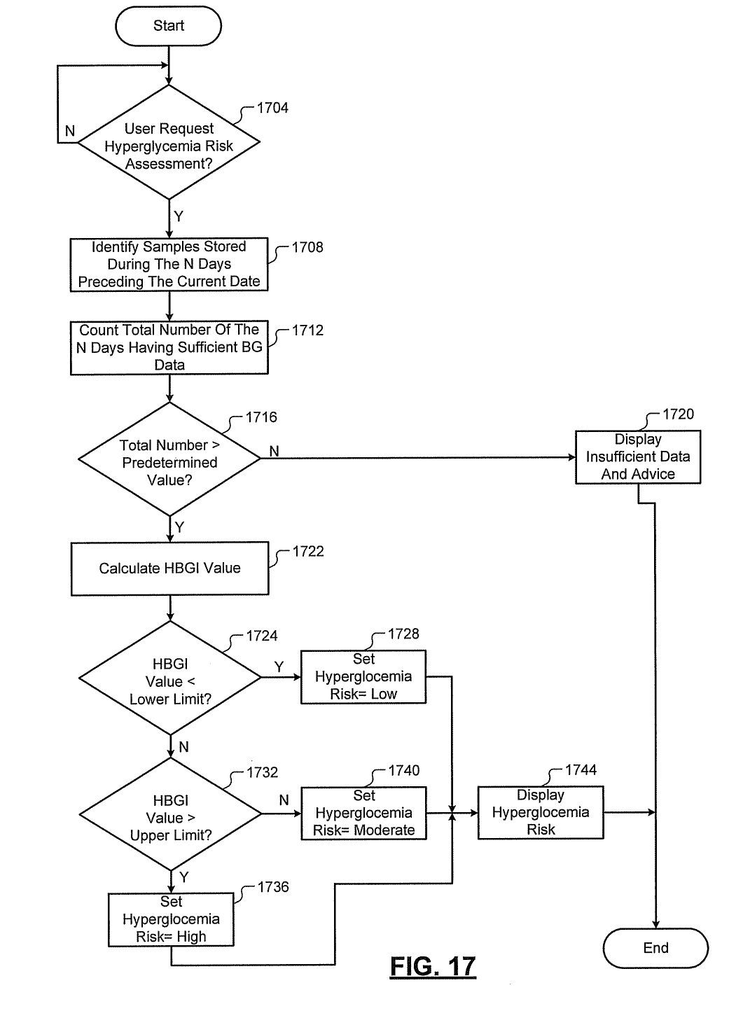

FIGS. 15 and 16 are flowcharts depicting example methods of calculating and displaying the user's risk of having hypoglycemia during the predetermined period in the future. The processor module 504 executes code stored in the statistics data 556 to perform the functions of FIGS. 15 and 16.

Referring now to FIG. 15, at 1504, the processor module 504 determines whether the user has requested an assessment of the user's risk of hypoglycemia during the predetermined period in the future be performed. The user may request performance of the assessment, for example, via one or more of the buttons 424-436. If 1504 is true, control continues with 1508. If 1504 is false, control may remain at 1504.

The processor module 504 determines whether the user input a sufficient number of blood samples during a sufficient number of days at 1508-1516. More specifically, at 1508, the processor module 504 identifies stored bG sample data associated with blood samples received during a first predetermined number (N) of (calendar) days. The first predetermined number of days may be the current day and the N−1 calendar days before the current date, or the first predetermined number of days may be the N calendar days immediately before the current day. The first predetermined number is an integer greater than one. The first predetermined number (N) may be greater than 6, greater than 13, greater than 20, or greater than 27. In various implementations, the first predetermined number may be equal to 7, 14, 21, 28, or another suitable number of days. The clock 518 provides the current date for identification of the relevant days.

The processor module 504 counts a total number (M) of the N days that the user input sufficient bG sample data at 1512. The total number of days is an integer less than or equal to N and greater than or equal to zero. Sufficient bG sample data may be bG sample data for at least two blood samples. The processor module 504 may require that the user input one blood sample before noon (time stamped with a.m.) and one blood sample after noon (time stamped with p.m.). In other words, the processor module 504 may count the total number (M) of the N days that the user input at least one blood sample before noon and at least one blood sample after noon.

At 1516, the processor module 504 determines whether the total number (of the N days) is greater than a second predetermined number. The second predetermined number is an integer greater than zero and less than or equal to the first predetermined number. For example only, the second predetermined number may be equal to 4, 7, 11, or 14 where the first predetermined number is 7, 14, 21, or 28, respectively. In various implementations, the second predetermined number may be another suitable number of days.

If 1516 is false, the processor module 504 may display a message on the display 408 at 1520 that indicates that there is insufficient bG sample data for performing the hypoglycemic risk assessment. The message may also include advice to help the user input sufficient bG sample data for the hypoglycemic risk assessment. For example, the message may indicate that, during a period of the first predetermined number of days, the user should input at least one blood sample before noon and at least one blood sample after noon on at least the second predetermined number of days. If 1516 is true, control may continue with 1522.

The processor module 504 calculates a low blood glucose index (LBGI) value for the user at 1522. The processor module 504 calculates the LBGI value based on the bG levels of all of the identified blood samples (i.e., the blood samples received during the first predetermined number of days). In an example embodiment, the processor module 504 may calculate the LBGI value as follows.

The processor module 504 determines an r(bG) value for each of the identified blood samples. The processor module 504 determines the r(bG) value for a blood sample using the following equation:

r(bG)=10*[1.509*(ln(bG)^{1.084}−5.381)]²,

where r(bg) is the r(bg) value for the blood sample, ln is the natural log function, and bG is the bG level (e.g., in mg/dL) of the blood sample. Using the above equation, a bG level of approximately 112 mg/dL (hyperglycemic) corresponds to an r(bG) value of approximately 0, and a bG level of 20 mg/dL (hypoglycemic) corresponds to an r(bG) value of approximately 100. The r(bG) values may be referred to as initial values.

When all of the r(bG) values have been determined (one per blood sample received during the first predetermined number of days), the processor module 504 determines a minimum one of the r(bG) values. The processor module 504 determines an rl(bG) value for each of the identified blood samples based on comparisons of the r(bG) values for the blood samples, respectively, and the minimum one of the r(bG) values. For example, the processor module 504 determines the rl(bG) value for a blood sample as follows:

rl(bG)=r(bG) if bG<the minimum one of the r(bG)values; and

rl(bG)=0 if bG≧the minimum one of the r(bG)values,

where bG is the bG level of the blood sample. The rl(bG) values may be referred to as secondary values.

The processor module 504 determines the LBGI value for the user based on an average of the rl(bG) values for the identified blood samples, respectively. This is represented mathematically by the following equation:

$$L B G I = \frac{1}{n} {\sum }_{i = 1}^{n} {rl ( bG )}_{i} ,$$

where LBGI is the LBGI value, rl(bg)ᵢ is the rl(bg) value of an i-th one of the identified blood samples, and n is the total number of the identified blood samples.

At 1524, the processor module 504 determines whether the LBGI value is less than a first predetermined value corresponding to a lower limit of a predetermined range. For example only, the first predetermined value may be approximately 2.5 or another suitable value. If 1524 is true, the processor module 504 sets a hypoglycemic risk indicator to a low risk state at 1528, and control continues with 1544, which is discussed further below. If 1524 is false, control continues with 1532.

The processor module 504 determines whether the LBGI value is greater than a second predetermined value corresponding to an upper limit of the predetermined range at 1532. For example only, the second predetermined value may be approximately 5.0 or another suitable value that is greater than the first predetermined value. If 1532 is true, the processor module 504 sets the hypoglycemic risk indicator to a high risk state at 1536, and control continues with 1544. If 1532 is false, the LBGI value is within the predetermined range, and the processor module 504 sets the hypoglycemic risk indicator to a moderate risk state at 1540. Control then continues with 1544.

The state of the hypoglycemic risk indicator indicates the user's risk of being hypoglycemic within the predetermined period (e.g., three to six months) in the future. At 1544, based on the state of the hypoglycemic risk indicator, the processor module 504 displays a message on the display 408 indicating the user's risk of being hypoglycemic within the predetermined period in the future. When the hypoglycemic risk indicator is in the low risk state, the processor module 504 displays a message on the display 408 indicating that the user is at low risk of being hypoglycemic within the predetermined period in the future. When the hypoglycemic risk indicator is in the moderate risk state, the processor module 504 displays a message on the display 408 indicating that the user is at moderate risk of being hypoglycemic within the predetermined period in the future. When the hypoglycemic risk indicator is in the high risk state, the processor module 504 displays a message on the display 408 indicating that the user is at high risk of being hypoglycemic within the predetermined period in the future.

In various implementations, the processor module 504 may limit instances of displaying hypoglycemic risk related information to times when the state of the hypoglycemic risk indicator increases. For example, at 1544, the processor module 504 may display a message on the display 408 indicating that the user is (then) at moderate risk of being hypoglycemic within the predetermined period in the future when the hypoglycemic risk indicator changes from the low risk state to the moderate risk state. When the hypoglycemic risk indicator changes from the moderate risk state to the high risk state, the processor module 504 may display a message on the display 408 indicating that the user is (then) at high risk of being hypoglycemic within the predetermined period in the future at 1544. Transitions from low risk to high risk may also be possible.

If the state of the hypoglycemic risk indicator does not increase, the processor module 504 may not display hypoglycemic risk related information on the display at 1544 in various implementations. For example, the processor module 504 may not display hypoglycemic risk related information when the state of the hypoglycemic risk indicator does not increase in the example of FIG. 16.

Unlike FIG. 15 where control continues with 1508 when the user has requested the assessment of the user's risk of hypoglycemia, in FIG. 16, the assessment may continue each time that the user inputs a blood sample. More specifically, referring now to FIG. 16A, at 1604 the processor module 504 may determine whether the user has input a blood sample. If 1604 is true, control may continue with 1508 as discussed above. For example, control may continue when the bG measurement engine 508 generates bG sample data based on a blood sample present on a bG test strip. If 1604 is false, control may remain at 1604. If a pattern is identified based on the sample received at 1604, however, the assessment may be aborted, and the processor module 504 may display an indicator of the pattern. While control is shown and discussed as ending, FIGS. 15 and 16 may be illustrative of one control loop, and control may return to begin again.

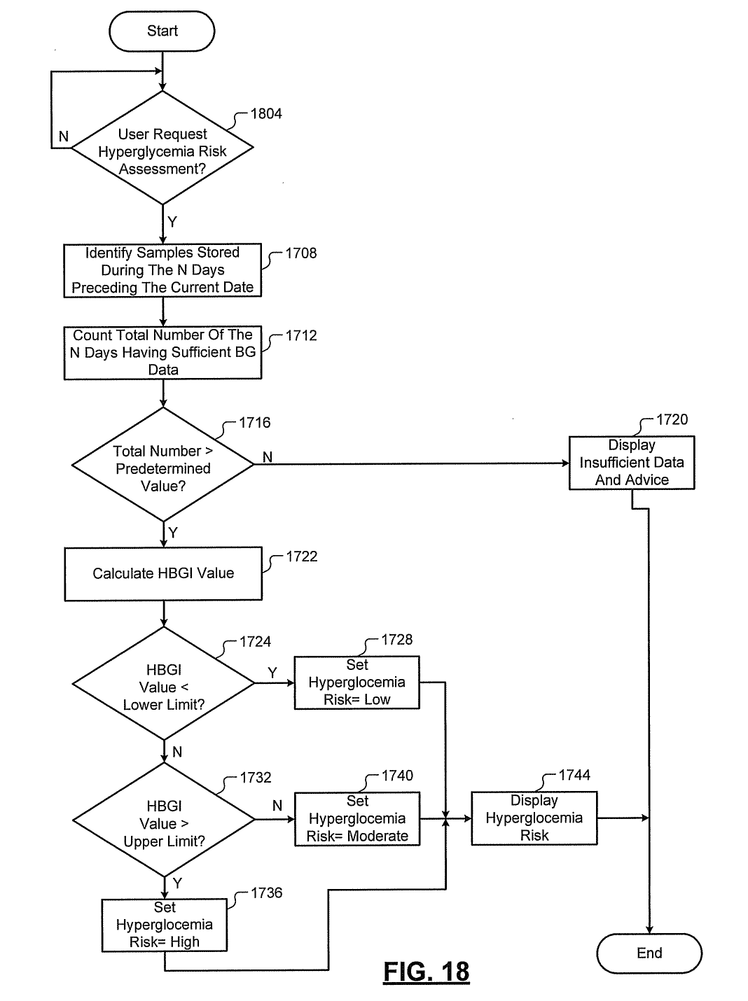

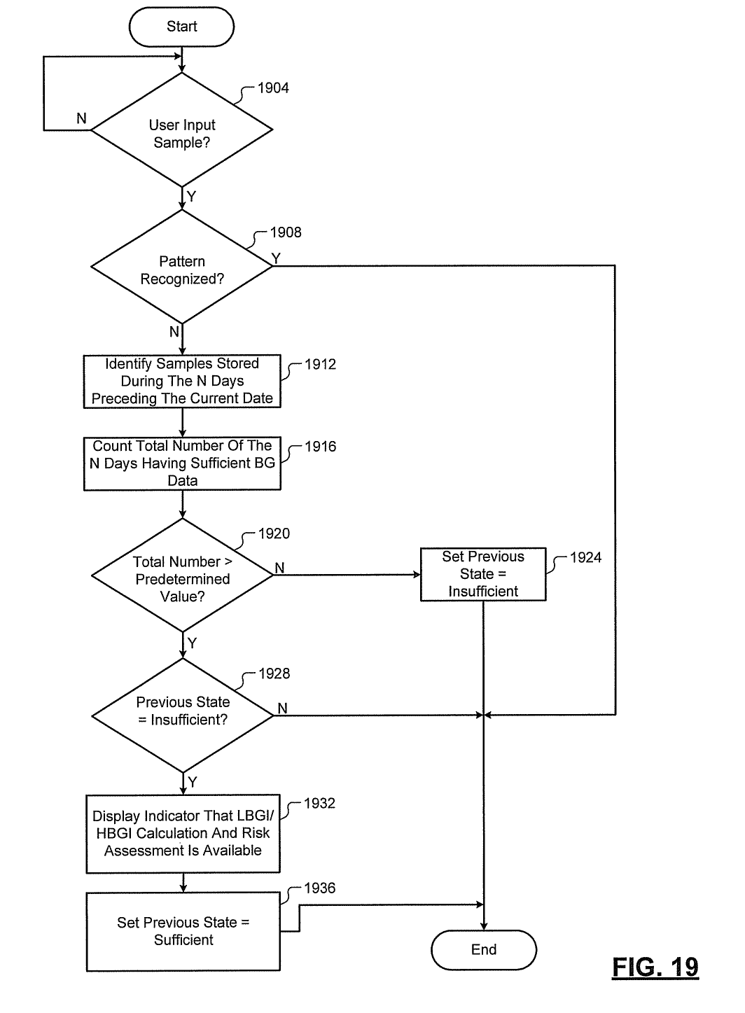

FIGS. 17 and 18 are flowcharts depicting example methods of calculating and displaying the user's risk of having hyperglycemia during a predetermined period (e.g., three to six months) in the future. The processor module 504 executes code stored in the statistics data 556 to perform the functions of FIGS. 17 and 18.

Referring now to FIG. 17, at 1704, the processor module 504 determines whether the user has requested an assessment of the user's risk of hyperglycemia during the predetermined period in the future be performed. The user may request performance of the assessment, for example, via one or more of the buttons 424-436. If 1704 is true, control continues with 1708. If 1704 is false, control may remain at 1704.

At 1708, the processor module 504 identifies stored bG sample data associated with blood samples received during the first predetermined number (N) of (calendar) days. The first predetermined number of days may be the current day and the N−1 calendar days before the current date, or the first predetermined number of days may be the N calendar days immediately before the current day. The first predetermined number is an integer greater than one. The first predetermined number (N) may be greater than 6, greater than 13, greater than 20, or greater than 27. In various implementations, the first predetermined number may be equal to 7, 14, 21, 28, or another suitable number of days. The clock 518 provides the current date for identification of the relevant days.

The processor module 504 counts a total number (M) of the N days that the user input sufficient bG sample data at 1712. The total number of days is an integer less than or equal to N and greater than or equal to zero. Sufficient bG sample data may be bG sample data for at least two blood samples. The processor module 504 may require that the user input one blood sample before noon (time stamped with a.m.) and one blood sample after noon (time stamped with p.m.). In other words, the processor module 504 may count the total number (M) of the N days that the user input at least one blood sample before noon and at least one blood sample after noon.

At 1716, the processor module 504 determines whether the total number (of the N days) is greater than the second predetermined number. The second predetermined number is an integer greater than zero and less than or equal to the first predetermined number. For example only, the second predetermined number may be equal to 4, 7, 11, or 14 where the first predetermined number is 7, 14, 21, or 28, respectively. In various implementations, the second predetermined number may be another suitable number of days.

If 1716 is false, the processor module 504 may display a message on the display 408 at 1720 that indicates that there is insufficient bG sample data for performing the hyperglycemic risk assessment. The message may also include advice to help the user input sufficient bG sample data for the hyperglycemic risk assessment. For example, the message may indicate that, during a period of the first predetermined number of days, the user should input at least one blood sample before noon and at least one blood sample after noon on at least the second predetermined number of days. If 1716 is true, control may continue with 1722.

The processor module 504 calculates a high blood glucose index (HBGI) value for the user at 1722. The processor module 504 calculates the HBGI value based on the bG levels of all of the identified blood samples (i.e., the blood samples received during the first predetermined number of days). In an example embodiment, the processor module 504 may calculate the HBGI value as follows.

The processor module 504 determines an r(bG) value for each of the identified blood samples. The processor module 504 determines the r(bG) value for a blood sample using the following equation:

r(bG)=10*[1.509*(ln(bG)^{1.084}−5.381)]²,

where r(bg) is the r(bg) value for the blood sample, ln is the natural log function, and bG is the bG level (e.g., in mg/dL) of the blood sample. Using the above equation, a bG level of approximately 112 mg/dL (hyperglycemic) corresponds to an r(bG) value of approximately 0, and a bG level of 20 mg/dL (hypoglycemic) corresponds to an r(bG) value of approximately 100. As stated above, the r(bG) values may be referred to as initial values.

When all of the r(bG) values have been determined (one per blood sample received during the first predetermined number of days), the processor module 504 determines a minimum one of the r(bG) values. The processor module 504 determines an rh(bG) value for each of the identified blood samples based on comparisons of the r(bG) values for the blood samples, respectively, and the minimum one of the r(bG) values. For example, the processor module 504 determines the rh(bG) value for a blood sample as follows:

rh(bG)=r(bG) if bG>the minimum one of the r(bG)values; and

rh(bG)=0 if bG≦the minimum one of the r(bG)values,

where bG is the bG level of the blood sample. The rh(bG) values may be referred to as secondary values.

The processor module 504 determines the HBGI value for the user based on an average of the rh(bG) values for the identified blood samples, respectively. This is represented mathematically by the following equation:

$$H B G I = \frac{1}{n} {\sum }_{i = 1}^{n} {rh ( bG )}_{i} ,$$

where HBGI is the HBGI value, rh(bg)ᵢ is the rh(bg) value of an i-th one of the identified blood samples, and n is the total number of the identified blood samples.

At 1724, the processor module 504 determines whether the HBGI value is less than a third predetermined value corresponding to a lower limit of a second predetermined range. For example only, the third predetermined value may be approximately 4.5 or another suitable value. If 1724 is true, the processor module 504 sets a hyperglycemic risk indicator to a low risk state at 1728, and control continues with 1744, which is discussed further below. If 1724 is false, control continues with 1732.

The processor module 504 determines whether the HBGI value is greater than a fourth predetermined value corresponding to an upper limit of the second predetermined range at 1732. For example only, the fourth predetermined value may be approximately 9 or another suitable value that is greater than the third predetermined value. If 1732 is true, the processor module 504 sets the hyperglycemic risk indicator to a high risk state at 1736, and control continues with 1744. If 1732 is false, the HBGI value is within the second predetermined range, and the processor module 504 sets the hyperglycemic risk indicator to a moderate risk state at 1740. Control then continues with 1744.

The state of the hyperglycemic risk indicator indicates the user's risk of being hyperglycemic within the predetermined period (e.g., three to six months) in the future. At 1744, based on the state of the hyperglycemic risk indicator, the processor module 504 displays a message on the display 408 indicating the user's risk of being hyperglycemic within the predetermined period in the future. When the hyperglycemic risk indicator is in the low risk state, the processor module 504 displays a message on the display 408 indicating that the user is at low risk of being hyperglycemic within the predetermined period in the future. When the hyperglycemic risk indicator is in the moderate risk state, the processor module 504 displays a message on the display 408 indicating that the user is at moderate risk of being hyperglycemic within the predetermined period in the future. When the hyperglycemic risk indicator is in the high risk state, the processor module 504 displays a message on the display 408 indicating that the user is at high risk of being hyperglycemic within the predetermined period in the future.

In various implementations, the processor module 504 may limit instances of displaying hyperglycemic risk related information to times when the state of the hyperglycemic risk indicator increases. For example, at 1744, the processor module 504 may display a message on the display 408 indicating that the user is (then) at moderate risk of being hyperglycemic within the predetermined period in the future when the hyperglycemic risk indicator changes from the low risk state to the moderate risk state. When the hyperglycemic risk indicator changes from the moderate risk state to the high risk state, the processor module 504 may display a message on the display 408 indicating that the user is (then) at high risk of being hyperglycemic within the predetermined period in the future at 1744. Transitions from low risk to high risk may also be possible.

If the state of the hyperglycemic risk indicator does not increase, the processor module 504 may not display hyperglycemic risk related information on the display at 1744 in various implementations. For example, the processor module 504 may not display hyperglycemic risk related information when the state of the hyperglycemic risk indicator does not increase in the example of FIG. 18.

Unlike FIG. 17 where control continues with 1708 when the user has requested the assessment of the user's risk of hyperglycemia, in FIG. 18, the assessment may continue each time that the user inputs a blood sample. More specifically, referring now to FIG. 18, at 1804 the processor module 504 may determine whether the user has input a blood sample. If 1804 is true, control may continue with 1708 as discussed above. For example, control may continue when the bG measurement engine 508 generates bG sample data based on a blood sample present on a bG test strip. If 1804 is false, control may remain at 1804. If a pattern is identified based on the sample received at 1804, however, the assessment may be aborted, and the processor module 504 may display an indicator of the pattern. While control is shown and discussed as ending, FIGS. 17 and 18 may be illustrative of one control loop, and control may return to begin again.

Referring now to FIG. 19, a flowchart depicting an example method of notifying the user that sufficient data has been input for performance of the hyperglycemic and/or hypoglycemic risk assessments is presented. The processor module 504 executes code stored in the statistics data 556 to perform the functions of FIG. 19.

Control may begin with 1904 where the processor module 504 may determine whether the user has input a blood sample. If 1904 is true, control may continue with 1908. For example, control may continue when the bG measurement engine 508 generates bG sample data based on a blood sample present on a bG test strip. If 1904 is false, control may remain at 1904.

At 1908, the processor module 504 may determine whether a pattern has been recognized. Pattern recognition is discussed above. If 1908 is true, control may end and information regarding the pattern may be displayed. If 1908 is false, control may continue with 1912. At 1912, the processor module 504 identifies stored bG sample data associated with blood samples received during the first predetermined number (N) of (calendar) days. The clock 518 provides the current date for identification of the relevant days.

The processor module 504 counts a total number (M) of the N days that the user input sufficient bG sample data at 1916. Sufficient bG sample data may be bG sample data for at least two blood samples. The processor module 504 may require that the user input one blood sample before noon (time stamped with a.m.) and one blood sample after noon (time stamped with p.m.). In other words, the processor module 504 may count the total number (M) of the N days that the user input at least one blood sample before noon and at least one blood sample after noon.

At 1920, the processor module 504 determines whether the total number (of the N days) is greater than the second predetermined number. The second predetermined number is an integer greater than zero and less than or equal to the first predetermined number. For example only, the second predetermined number may be equal to 4, 7, 11, or 14 where the first predetermined number is 7, 14, 21, or 28, respectively. In various implementations, the second predetermined number may be another suitable number of days.

If 1920 is false, the processor module 504 may set a previous state indicator to an insufficient state at 1924, and control may end. The previous state indicator indicates whether sufficient bG data was available for performance of a hyperglycemic risk assessment and/or a hypoglycemic risk assessment before the blood sample was received at 1904. If 1920 is true, control may continue with 1928.

At 1928, the processor module 504 determines whether the previous state indicator is set to the insufficient state (indicating that there was insufficient bG data for performance of a hyperglycemic risk assessment and/or a hypoglycemic risk assessment before the blood sample was received at 1904). If 1928 is true, control may continue with 1932. If 1928 is false, control may end.

The processor module 504 displays a message on the display 408 indicating that there is now sufficient bG data to perform a hyperglycemic risk assessment and/or a hypoglycemic risk assessment at 1932. In this manner, the user is informed that the user can request performance of a hyperglycemic risk assessment and/or a hypoglycemic risk assessment to determine the user's risk of having hyperglycemia and/or hypoglycemia during the predetermined period in the future. At 1936, the processor module 504 sets the previous state indicator to a sufficient state, and control may end. Setting the previous state indicator to the sufficient state at 1936 prevents the user from being notified repeatedly of the availability of performance of a hyperglycemic risk assessment and/or a hypoglycemic risk assessment once sufficient bG data is available. While control is shown and discussed as ending, FIG. 19 may be illustrative of one control loop, and control may return to begin again.

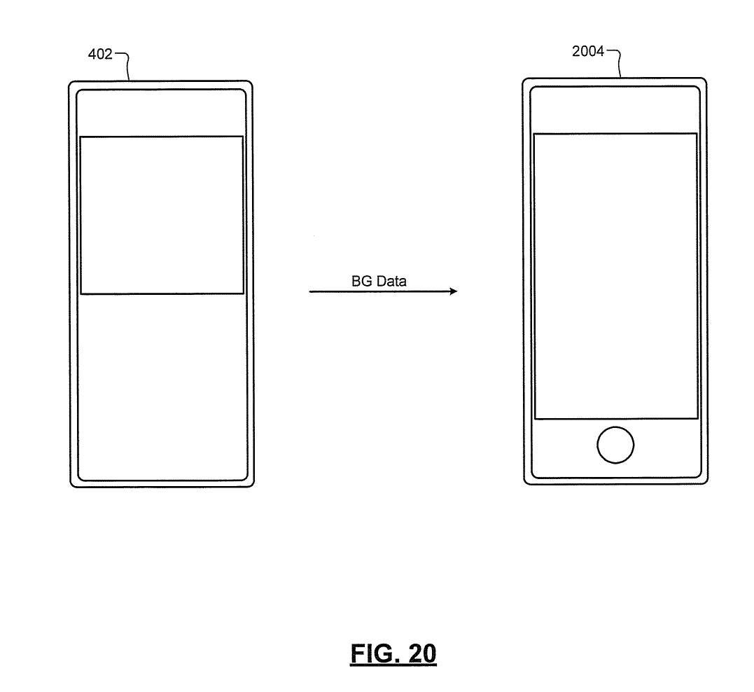

While FIGS. 15-19 have been discussed as being functions of the diabetes management device 402, the functions of FIGS. 15-19 can instead be performed by a mobile computing device, such as a smartphone, a portable media player, or a tablet computer. For example, as shown in FIG. 20, the diabetes management device 402 can transfer stored bG sample data to mobile computing device 2004. The transfer may be wirelessly or by wire. The mobile computing device 2004 includes code for executing the functions described above in conjunction with FIGS. 15-19.

A handheld diabetes management device for assessing a patient's risk of future hypoglycemia is disclosed. A blood glucose (bG) measurement engine selectively measures bG levels in blood samples input to the handheld diabetes management device. A computer readable medium includes code executed by a processor to: identify a period of N days, the period including the current date and N−1 days immediately prior to the current date, wherein N is an integer greater than 6; determine a total number of the N days during which the patient input at least two blood samples to the handheld diabetes management device; and, when the total number of the N days is greater than M, M being an integer greater than zero and less than or equal to N: calculate a value based on the bG levels of blood samples input to the handheld diabetes management device during the period; based on the value, classify the patient as having a first, second, or third risk of being hypoglycemic in the future, the second risk being greater than the first risk, and the third risk being greater than the second risk; and display the classification of the patient's risk of being hypoglycemic on the display.

In further features, N is equal to 28.

In still further features, M is equal to 14.

In yet further features, calculating the value includes calculating the value based on all the bG levels of blood samples input to the handheld diabetes management device during the period.

In further features, classifying includes: classifying the patient as having the first risk when the value is less than a first predetermined value; classifying the patient as having the second risk when the value is greater than the first predetermined value and less than a second predetermined value; and classifying the patient as having the third risk when the value is greater than the second predetermined value.

In still further features, calculating the value includes: determining initial values (r(bg)) for the blood samples, respectively, using the equation:

r(bG)=10*[1.509*(ln(bG)^{1.084}−5.381)]²,

where r(bg) is the initial value for a blood sample, ln is the natural log function, and bG is the bG level of the blood sample; determining a minimum one of the initial values; determining secondary values (rl(bg)) for the blood samples, respectively, using the relationships:

rl(bG)=r(bG) if bG<the minimum one of the r(bG)values; and

rl(bG)=0 if bG≧the minimum one of the r(bG)values; and

setting the value equal to an average of the secondary values.

In yet further features, classifying includes: classifying the patient as having the first risk when the value is less than 2.5; classifying the patient as having the second risk when the value is greater than 2.5 and less than 5.0; and classifying the patient as having the third risk when the value is greater than 5.0.

In still further features, N is greater than 13.

In further features, N is greater than 20.

In yet further features, N is greater than 27.

In still further features, M is greater than 13.

A method for assessing a patient's risk of future hypoglycemia using a handheld diabetes management devices is also disclosed. The method includes: determining blood glucose (bG) values based on blood samples input to the handheld diabetes management device, each of the bG values indicative of an amount of glucose in one of the blood samples; tracking a current date and time; identifying a period of N days, the period including the current date and N−1 days immediately prior to the current date, wherein N is an integer greater than 6; determining a total number of the N days during which the patient input at least two blood samples to the handheld diabetes management device; and, when the total number of the N days is greater than M, M being an integer greater than zero and less than or equal to N: calculating a low blood glucose index (LBGI) value based on the bG values of blood samples input to the handheld diabetes management device during the period; based on the LBGI value, classifying the patient as having a first, second, or third risk of being hypoglycemic in the future, the second risk being greater than the first risk, and the third risk being greater than the second risk; and displaying the classification of the patient's risk of being hypoglycemic on a display of the handheld diabetes management device

In further features, N is equal to 28.

In still further features, M is equal to 14.

In yet further features, calculating the LBGI value includes calculating the LBGI value based on all the bG values of the blood samples input to the handheld diabetes management device during the period.

In further features, classifying includes: classifying the patient as having the first risk when the LBGI value is less than a first predetermined value; and classifying the patient as having the second risk when the LBGI value is greater than the first predetermined value and less than a second predetermined value.

In still further features, classifying further includes: classifying the patient as having the third risk when the LBGI value is between the first and second predetermined values.

In yet further features, calculating the value includes: determining initial values (r(bg)) for the blood samples, respectively, using the equation:

r(bG)=10*[1.509*(ln(bG)^{1.084}−5.381)]²,

where r(bg) is the initial value for a blood sample, ln is the natural log function, and bG is the bG level of the blood sample; determining a minimum one of the initial values; determining secondary values (rl(bg)) for the blood samples, respectively, using the relationships:

rl(bG)=r(bG) if bG<the minimum one of the r(bG)values; and

rl(bG)=0 if bG≧the minimum one of the r(bG)values; and

setting the value equal to an average of the secondary values.

In further features, classifying includes: classifying the patient as having the first risk when the LBGI value is less than 2.5; classifying the patient as having the second risk when the LBGI value is greater than 2.5 and less than 5.0; and classifying the patient as having the third risk when the LBGI value is greater than 5.0.

A diabetes management system for assessing a patient's risk of future hypoglycemia is also disclosed. A handheld diabetes management device includes: a blood glucose (bG) measurement engine that selectively measures bG levels in blood samples input to the handheld diabetes management device; and a communication module that selectively transmits data indicative of stored bG data. A mobile device is external to the handheld diabetes management device, receives the data indicative of the stored bG data from the handheld diabetes management device. The mobile device: identifies a period of N days, the period including a current date and N−1 days immediately prior to the current date, wherein N is an integer greater than 6; determines a total number of the N days during which the patient input at least two blood samples to the handheld diabetes management device; and, when the total number of the N days is greater than M, M being an integer greater than zero and less than or equal to N: calculates a value based on the bG levels of blood samples input to the handheld diabetes management device during the period; based on the value, classifies the patient as having a first, second, or third risk of being hypoglycemic in the future, the second risk being greater than the first risk, and the third risk being greater than the second risk; and displays the classification of the patient's risk of being hypoglycemic on a display of the mobile device.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A handheld diabetes management device for assessing a patient's risk of future hypoglycemia, the handheld diabetes management device comprising:
a blood glucose (bG) measurement engine that selectively measures bG levels in blood samples input to the handheld diabetes management device;
a display;
a clock tracking a current date and time;
a processor; and
a computer readable medium including code executed by the processor to:
identify a period of N days, the period including the current date and N−1 days immediately prior to the current date, wherein N is an integer greater than 6;
determine a total number of the N days during which the patient input at least two blood samples to the handheld diabetes management device; and
when the total number of the N days is greater than M, M being an integer greater than zero and less than or equal to N:
calculate a value based on the bG levels of blood samples input to the handheld diabetes management device during the period;
based on the value, classify the patient as having a first, second, or third risk of being hypoglycemic in the future, the second risk being greater than the first risk, and the third risk being greater than the second risk; and
display the classification of the patient's risk of being hypoglycemic on the display.

2. The handheld diabetes management device of claim 1 wherein N is equal to 28.

3. The handheld diabetes management device of claim 2 wherein M is equal to 14.

4. The handheld diabetes management device of claim 1 wherein calculating the value includes calculating the value based on all the bG levels of blood samples input to the handheld diabetes management device during the period.

5. The handheld diabetes management device of claim 1 wherein classifying includes:
classifying the patient as having the first risk when the value is less than a first predetermined value;
classifying the patient as having the second risk when the value is greater than the first predetermined value and less than a second predetermined value; and
classifying the patient as having the third risk when the value is greater than the second predetermined value.

6. The handheld diabetes management device of claim 1 wherein calculating the value includes:
determining initial values (r(bg)) for the blood samples, respectively, using the equation:
r(bG)=10*[1.509*(ln(bG)^{1.084}−5.381)]²,
where r(bg) is the initial value for a blood sample, ln is the natural log function, and bG is the bG level of the blood sample;
determining a minimum one of the initial values;
determining secondary values (rl(bg)) for the blood samples, respectively, using the relationships:
rl(bG)=r(bG) if bG<the minimum one of the r(bG)values; and
rl(bG)=0 if bG>the minimum one of the r(bG)values; and
setting the value equal to an average of the secondary values.

7. The handheld diabetes management device of claim 6 wherein classifying includes:
classifying the patient as having the first risk when the value is less than 2.5;
classifying the patient as having the second risk when the value is greater than 2.5 and less than 5.0; and
classifying the patient as having the third risk when the value is greater than 5.0.

8. The handheld diabetes management device of claim 1 wherein N is greater than 13.

9. The handheld diabetes management device of claim 1 wherein N is greater than 20.

10. The handheld diabetes management device of claim 1 wherein N is greater than 27.

11. The handheld diabetes management device of claim 1 wherein M is greater than 13.

12. A method for assessing a patient's risk of future hypoglycemia, the method performed by a handheld diabetes management device, and the method comprising:
determining blood glucose (bG) values based on blood samples input to the handheld diabetes management device, each of the bG values indicative of an amount of glucose in one of the blood samples;
tracking a current date and time;
identifying a period of N days, the period including the current date and N−1 days immediately prior to the current date, wherein N is an integer greater than 6;
determining a total number of the N days during which the patient input at least two blood samples to the handheld diabetes management device; and
when the total number of the N days is greater than M, M being an integer greater than zero and less than or equal to N:
calculating a low blood glucose index (LBGI) value based on the bG values of blood samples input to the handheld diabetes management device during the period;
based on the LBGI value, classifying the patient as having a first, second, or third risk of being hypoglycemic in the future, the second risk being greater than the first risk, and the third risk being greater than the second risk; and
displaying the classification of the patient's risk of being hypoglycemic on a display of the handheld diabetes management device.

13. The method of claim 12 wherein N is equal to 28.

14. The method of claim 13 wherein M is equal to 14.

15. The method of claim 12 wherein calculating the LBGI value includes calculating the LBGI value based on all the bG values of the blood samples input to the handheld diabetes management device during the period.

16. The method of claim 12 wherein classifying includes:
classifying the patient as having the first risk when the LBGI value is less than a first predetermined value; and
classifying the patient as having the second risk when the LBGI value is greater than the first predetermined value and less than a second predetermined value.

17. The method of claim 16 wherein classifying further includes:
classifying the patient as having the third risk when the LBGI value is between the first and second predetermined values.

18. The method of claim 12 wherein calculating the value includes:
determining initial values (r(bg)) for the blood samples, respectively, using the equation:
r(bG)=10*[1.509*(ln(bG)^{1.084}−5.381)]²,
where r(bg) is the initial value for a blood sample, ln is the natural log function, and bG is the bG level of the blood sample;
determining a minimum one of the initial values;
determining secondary values (rl(bg)) for the blood samples, respectively, using the relationships:
rl(bG)=r(bG) if bG<the minimum one of the r(bG)values; and
rl(bG)=0 if bG≧the minimum one of the r(bG)values; and
setting the value equal to an average of the secondary values.

19. The method of claim 18 wherein classifying includes:
classifying the patient as having the first risk when the LBGI value is less than 2.5;
classifying the patient as having the second risk when the LBGI value is greater than 2.5 and less than 5.0; and
classifying the patient as having the third risk when the LBGI value is greater than 5.0.

20. A diabetes management system for assessing a patient's risk of future hypoglycemia, the diabetes management system comprising:
a handheld diabetes management device including:
a blood glucose (bG) measurement engine that selectively measures bG levels in blood samples input to the handheld diabetes management device; and
a communication module that selectively transmits data indicative of stored bG data; and
a mobile device that is external to the handheld diabetes management device, that receives the data indicative of the stored bG data from the handheld diabetes management device, and that:
identifies a period of N days, the period including a current date and N−1 days immediately prior to the current date, wherein N is an integer greater than 6;
determines a total number of the N days during which the patient input at least two blood samples to the handheld diabetes management device; and
when the total number of the N days is greater than M, M being an integer greater than zero and less than or equal to N:
calculates a value based on the bG levels of blood samples input to the handheld diabetes management device during the period;
based on the value, classifies the patient as having a first, second, or third risk of being hypoglycemic in the future, the second risk being greater than the first risk, and the third risk being greater than the second risk; and
displays the classification of the patient's risk of being hypoglycemic on a display of the mobile device.
